(19) United States
(12) Patent Application Publication
(10) Pub. No.: US 2026/0058380 A1
(43) Pub. Date: Feb. 26, 2026

(54) GROUNDING LUG SYSTEM AND A GROUNDING LUG

(71) Applicant: Unirac, Inc., Albuquerque, NM (US)

(72) Inventors: Vignesh Karthikeyan, Rai Durg (IN); Jukanti Shiva, Hyderabad (IN)

(73) Assignee: Unirac, Inc., Albuquerque, NM (US)

(21) Appl. No.: 18/814,898

(22) Filed: Aug. 26, 2024

(51) Int. Cl. H01R 4/66; H01R 4/42

(52) U.S. Cl. CPC H01R 4/66; H01R 4/42

(57) ABSTRACT

A grounding lug system includes a retention bracket, which includes a first leg having a first aperture defined through a thickness thereof, and a second leg connected to the first leg via a folded portion. The second leg has a second aperture defined through a thickness thereof; and a fastener is configured to extend through the first aperture and the second aperture.

### TECHNICAL FIELD

The present disclosure relates generally to grounding lugs. Specifically, the present disclosure relates to systems and apparatuses for providing an electrical path to ground for wires associated with an array of solar panels.

### BACKGROUND

Utilization of photovoltaic cells within solar panels is becoming ubiquitous throughout residential, commercial, and governmental properties as a means to obtain free and renewable energy through the production of direct current (DC) electricity. These solar panels may be affixed to or mounted on a building such as a roof of a home or other building or other mounting surfaces. In order to avoid the potential for any damage occurring to the mounting surfaces, the solar panels and associated cabling, wiring, electrical modules, frames, and mounting devices may be designed to be easily installed and minimally invasive or destructive to the mounting surfaces.

Among the cabling, wiring, electrical modules, framing, and mounting devices associated with the installation of solar panel systems, the ground wiring and electrical modules may create a potential electrical hazard if these elements are not properly secured and are appropriately grounded. Ground wires are essential for electrical systems including solar panel arrays because they provide a safe way for excess electrical charges to reach the ground, which has a negative electrical charge. This protects individuals and buildings from electrical shock, fire, and short circuits during electrical malfunctions, such as lightning strikes, power outages, or damaged wires. For example, loose ground wires may potentially cause electrical shorts or unintended wearing of the electrical systems of the solar panel systems.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a retention bracket of a grounding lug system, according to an example of the principles described herein.

FIG. 2 illustrates a t-bolt of a grounding lug system, according to an example of the principles described herein.

FIG. 3 illustrates a side view of the grounding lug system including the retention bracket of FIG. 1 and the t-bolt of FIG. 2, according to an example of the principles described herein.

FIG. 4 illustrates a retention bracket of a grounding lug system, according to an example of the principles described herein.

FIG. 5 illustrates a grounding lug system including the retention bracket of FIG. 4 and the t-bolt of FIG. 2 connected to a rail, according to an example of the principles described herein.

FIG. 6 illustrates a retention bracket and the t-bolt of FIG. 2, according to an example of the principles described herein.

FIG. 7 illustrates a grounding lug system including the retention bracket of FIG. 6 as connected with a rail, according to an example of the principles described herein.

FIG. 8 illustrates a rail including markings created when the grounding lug system of FIG. 6 is connected with the rail 302, according to an example of the principles described herein.

FIG. 9 illustrates a retention bracket of a grounding lug system, according to an example of the principles described herein.

FIG. 10 illustrates the retention bracket of FIG. 9 incorporated with the grounding lug system and connected with a rail, according to an example of the principles described herein.

FIG. 11 illustrates a retention bracket of a grounding lug system, according to an example of the principles described herein.

FIG. 12 illustrates the retention bracket of FIG. 11 incorporated with the grounding lug system and connected with a rail, according to an example of the principles described herein.

FIG. 13 illustrates a retention bracket of a grounding lug system, according to an example of the principles described herein.

FIG. 14 illustrates the retention bracket of FIG. 13 incorporated with the grounding lug system and connected with a rail, according to an example of the principles described herein.

FIG. 15 illustrates a retention bracket of a grounding lug system, according to an example of the principles described herein.

FIG. 16 illustrates the retention bracket of FIG. 15 incorporated with the grounding lug system and connected with a rail, according to an example of the principles described herein.

FIG. 17 illustrates a retention bracket of a grounding lug system, according to an example of the principles described herein.

FIG. 18 illustrates the retention bracket of FIG. 17 incorporated with the grounding lug system and connected with a rail, according to an example of the principles described herein.

FIG. 19 illustrates a top perspective view of a retention bracket incorporated with a grounding lug system and connected with a rail, according to an example of the principles described herein.

FIG. 20 illustrates a top perspective view of the retention bracket incorporated with a grounding lug system of FIG. 19, according to an example of the principles described herein.

FIG. 21 illustrates a side view of a retention bracket incorporated with a grounding lug system and connected with a rail, according to an example of the principles described herein.

FIG. 22 illustrates a side view of a retention bracket incorporated with a grounding lug system and connected with a rail, according to an example of the principles described herein.

FIG. 23 illustrates a top perspective view of the retention bracket incorporated with a grounding lug system of FIG. 22, according to an example of the principles described herein.

FIG. 24 illustrates a side view of a retention bracket incorporated with a grounding lug system and connected with a rail, according to an example of the principles described herein.

FIG. 25 illustrates a side view of a retention bracket incorporated with a grounding lug system and connected with a rail, according to an example of the principles described herein.

FIG. 26 illustrates a top perspective view of the retention bracket incorporated with a grounding lug system of FIG. 25 and connected with a rail, according to an example of the principles described herein.

FIG. 27 illustrates a top perspective view of a retention bracket incorporated with a grounding lug system and connected with a rail, according to an example of the principles described herein.

FIG. 28 illustrates a top perspective view of a retention bracket incorporated with a grounding lug system and connected with a rail, according to an example of the principles described herein.

FIG. 29 illustrates a top perspective view of a retention bracket incorporated with a grounding lug system and connected with a rail, according to an example of the principles described herein.

FIG. 30 illustrates a top perspective view of the retention bracket incorporated with a grounding lug system of FIG. 29 and connected with a rail, according to an example of the principles described herein.

FIG. 31 illustrates a top perspective view of a retention bracket incorporated with a grounding lug system and connected with a rail, according to an example of the principles described herein.

FIG. 32 illustrates a top perspective view of the retention bracket incorporated with a grounding lug system of FIG. 31 and connected with a rail, according to an example of the principles described herein.

FIG. 33 illustrates a side perspective view of a retention bracket incorporated with a grounding lug system and connected with a rail, according to an example of the principles described herein.

FIG. 34 illustrates a side perspective view of a retention bracket incorporated with a grounding lug system and connected with a rail, according to an example of the principles described herein.

### DESCRIPTION OF EXAMPLE EMBODIMENTS

### Overview

This disclosure describes example grounding lug systems that include example retention brackets. The retention brackets may include a first leg and a second leg that extend parallel to one another, and which may both have apertures through which a fastener used to connect the retention bracket to a rail may extend. The example grounding lug systems are couplable to the rail and may be used to ground wires such as uninsulated copper wires to the rail and, subsequently, to ground (e.g., circuit ground or earth ground).

The examples described herein provide for inexpensive grounding lug systems that may be easily assembled on, for example, a rooftop or similar construction or installation venue rather than requiring preassembly. The grounding lug systems may be compatible to interface with various types of rails and rail systems and may require minimal tooling to install such as a socket wrench or similar singular tool. Further, the examples described herein provide for grounding lug systems that may be used to connect a wide range of wire gauges such as, for example, between 6 and 12 American wire gauge (AWG) solid copper wires.

Examples described herein provide a grounding lug system including a retention bracket. The retention bracket may include a first aperture defined in a first leg of the retention bracket and a second aperture defined in a second leg of the retention bracket. The grounding lug system may include a fastener coupling the retention bracket to a rail. The fastener may extend through the first aperture and the second aperture.

The grounding lug system may further include a flange extending from the retention bracket. The flange may be formed on an end of at least one of the first leg or the second leg. The flange may be dimensioned to retain a wire within the retention bracket. The fastener may include a t-bolt and a nut mechanically couplable to the t-bolt. The retention bracket may be deformable as the t-bolt mechanically engages with the nut.

The grounding lug system may further include a tab extending perpendicular to the second leg of the retention bracket to retain an orientation of the retention bracket with respect to a rail to which the retention bracket is connected.

Examples described herein also provide a grounding lug system including a retention bracket. The retention bracket may include a first leg and a second leg. Further, the retention bracket may include a fastener coupling the retention bracket to a rail. The retention bracket may further include a tab extending perpendicular to the second leg of the retention bracket to retain an orientation of the retention bracket with respect to a rail to which the retention bracket is connected.

The grounding lug system may further include a flange extending from the retention bracket. The flange may be formed on an end of at least one of the first leg or the second leg. The flange may be dimensioned to retain a wire within the retention bracket. The fastener may include a t-bolt and a nut mechanically couplable to the t-bolt. The t-bolt may include a threaded shaft, a head connected to the threaded shaft and perpendicular to the threaded shaft, and a ridge formed on a side of the head closest to the threaded shaft. The threaded shaft, head, and ridge may include an electrically conductive material.

The grounding lug system may further include a first aperture defined in a first leg of the retention bracket and a second aperture defined in a second leg of the retention bracket, the fastener extending through the first aperture and the second aperture.

Examples described herein also provide a retention bracket including a first leg, a second leg, and a tab extending perpendicular to the second leg of the retention bracket to retain an orientation of the retention bracket with respect to a rail to which the retention bracket is connected.

The retention bracket may further include a flange extending from the retention bracket. The flange may be formed on an end of at least one of the first leg or the second leg. The flange may be dimensioned to retain a wire within the retention bracket. The retention bracket may further include a first aperture defined in a first leg of the retention bracket, and a second aperture defined in a second leg of the retention bracket. The retention bracket may include an electrically conductive material.

### Example Embodiments

This disclosure describes techniques for securing ground wires to solar panel arrays. The solar panel arrays may include rails used to directly or indirectly secure the solar panel arrays to a mounting surface. The example grounding lug systems may be connected to the rails via a channel defined in the rail. The grounding lug systems may include a retention bracket through which a fastener such as a t-bolt may be extended to connect the retention bracket to the rail and to cause the retention bracket to engage with the ground wire(s).

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

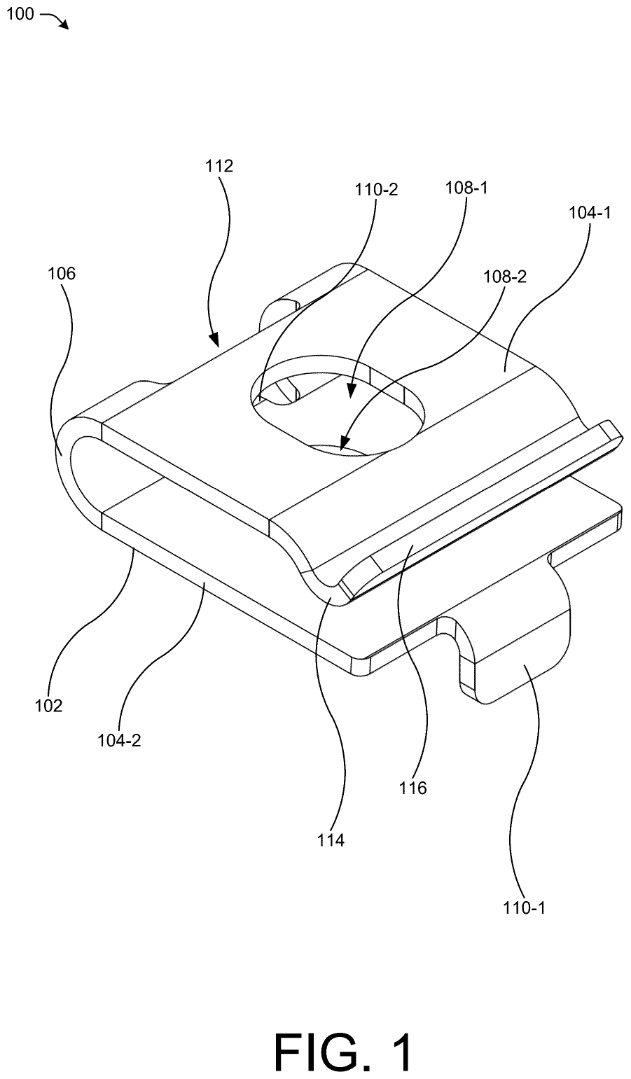

FIG. 1 illustrates a retention bracket 100 of a grounding lug system, according to an example of the principles described herein. This example of the retention bracket 100 and other examples of retention brackets described herein may be used to electrically connect one or more ground wires to a rail of a solar panel system. The rails of the solar panel system may then be electrically connected to circuit ground and/or earth ground to properly ground the ground wire(s) and electrically protect the solar panel system. The examples of retention brackets described herein may have various features which may be individually incorporated into other examples.

The retention bracket 100 may include a main body 102 having a u-shaped cross-section including a base 106, a first leg 104-1 extending from the base 106, and a second leg 104-2 extending from the base 106. The distance between the first leg 104-1 and the second leg 104-2 may be large enough to accommodate ground wires of various gauges.

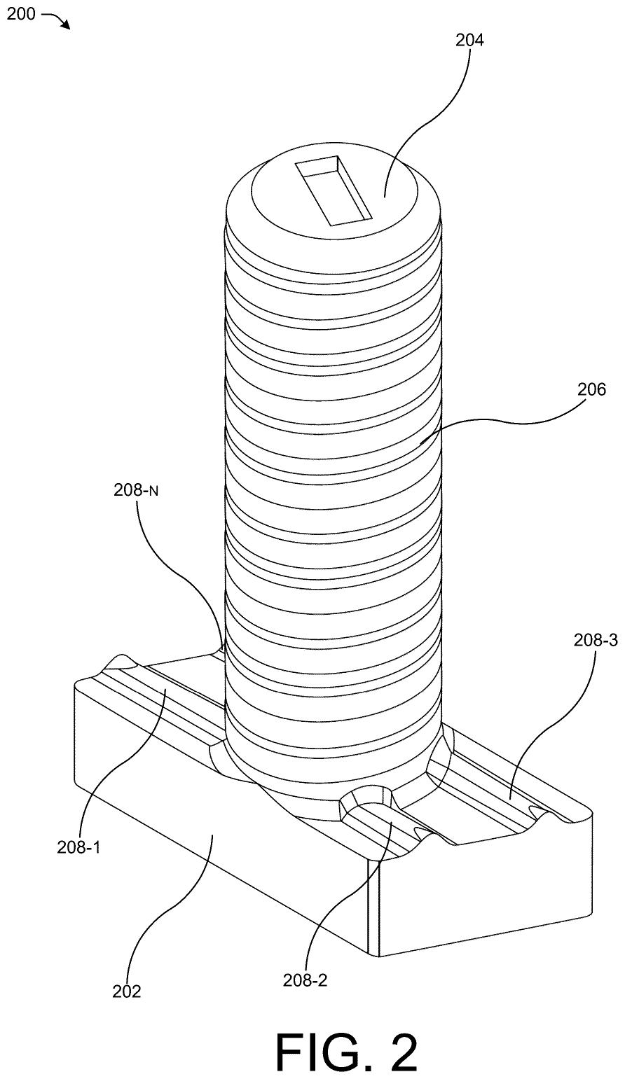

The first leg 104-1 may include a first aperture 108-1 defined therein. Similarly, the second leg 104-2 may include a second aperture 108-2 defined therein. The first aperture 108-1 and the second aperture 108-2 may accommodate for a t-bolt (200, FIG. 2) to extend through the retention bracket 100 and connect the retention bracket 100 to a rail as will be described in more detail herein. The first aperture 108-1 and the second aperture 108-2 may have an oval shape. The t-bolt (200, FIG. 2) is used to connect the retention bracket 100 to the rail and clamp the ground wire(s) between the first leg 104-1 and the second leg 104-2. When the t-bolt (200, FIG. 2) is tightened the first aperture 108-1 may or may not continue to be aligned with respect to the second aperture 108-2 to allow for the retention bracket 100 to secure differently-sized ground wires when the t-bolt (200, FIG. 2) is used to connect the retention bracket 100 to the rail and clamp the ground wire(s) between the first leg 104-1 and the second leg 104-2. Although not much movement may occur between the alignment of the first aperture 108-1 and the second aperture 108-2, the oval shape of the first aperture 108-1 and the second aperture 108-2 allows for the t-bolt (200, FIG. 2) to not bind with the first aperture 108-1 and/or the second aperture 108-2.

The retention bracket 100 may further include a depression 114 extending from the first leg 104-1 and a flange 116 extending from the depression 114. The depression 114 extends into the space between the first leg 104-1 and the second leg 104-2, and the flange 116 extends away from the space between the first leg 104-1 and the second leg 104-2. In this manner, the depression 114 and the flange 116 serve to retain any wires (e.g., the ground wire(s) 308) that are introduced into the space between the first leg 104-1 and the second leg 104-2. The flange 116 may be formed at an end of the first leg 104-1 and/or the second leg 104-2 at an angle to the first leg 104-1 and the second leg 104-2 to provide a lead-in feature or to facilitate insertion or installation of a ground wire 308 into the retention bracket 100. one example, the Retention bracket 100 may be subjected to annealing, tempering, or other heat treatments to obtain a retention bracket 100 that is able to retain a spring bias. This spring bias may be used in connection with the flange 116 such that as a user inserts a ground wire 308 into the retention bracket 100 between the first leg 104-1 and the second leg 104-2, the lead-in feature of the flange 116 guides the direction of the ground wire 308 and the spring bias allows the retention bracket 100 to be deformed (e.g., elastic deformation or plastic deformation) as the ground wire 308 is pushed past the depression 114 and seated between the depression 114 and a shaft 204 of the t-bolt 200.

The retention bracket 100 may further include an aperture 112 defined in the base 106. Further, a first orientation tab 110-1 and a second orientation tab 110-2 may extend from the second leg 104-2 and turn downwards below the second leg 104-2. In one example, the second orientation tab 110-2 may be formed by cutting the second orientation tab 110-2 from the base 106 and bending the second orientation tab 110-2 to extend from the second leg 104-2 and turn downwards below the second leg 104-2 and in order to form the aperture 112.

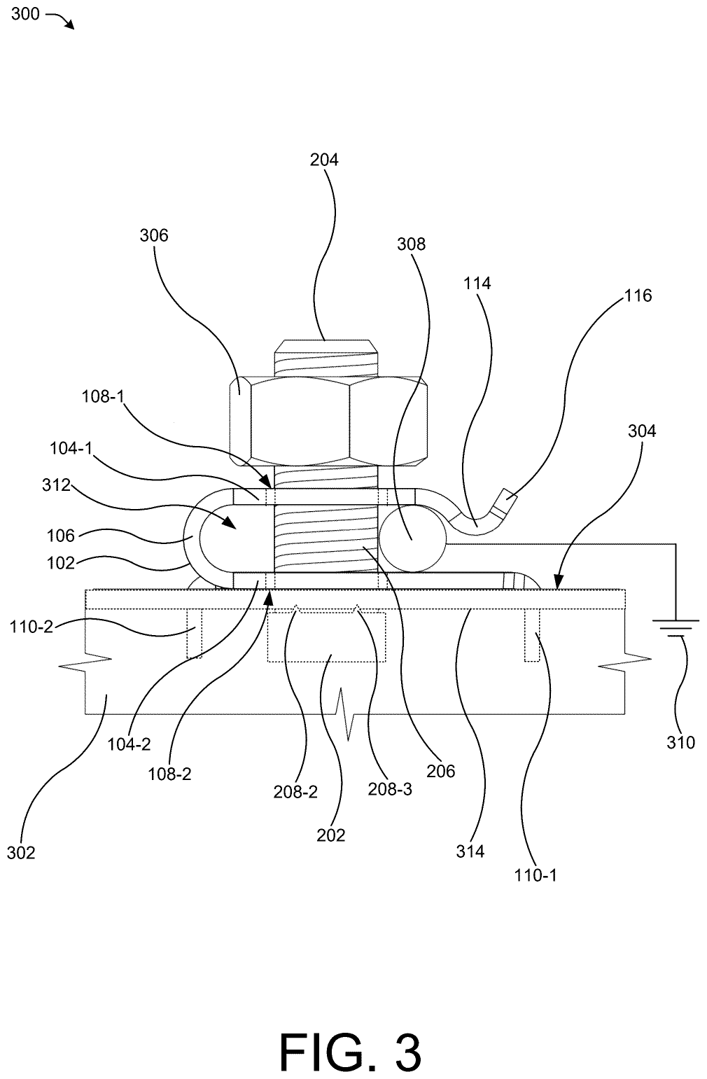

The first orientation tab 110-1 and the second orientation tab 110-2 may be used to retain the retention bracket 100 in a desired orientation with respect to a rail to which the retention bracket 100 may be connected. For example, the first orientation tab 110-1 and the second orientation tab 110-2 may extend into a channel 304 of a rail as depicted in FIG. 3 and other figures that depict a rail 302 with retention brackets that include an orientation tab.

In examples descried herein where orientation tabs such as orientation tabs 110-1, 110-2 are described, the orientation tabs may have any number of shapes and sizes. For example, the orientation tabs described herein may include the rounded-square shape as depicted in, for example, FIG. 1. However, in other examples, the orientation tabs may have a square shape, a triangular shape, or a trapezoidal shape, among other shapes. In one example, the orientation tabs may have a shape that allows for the orientation tab of the retention bracket 100 or similar element to penetrate an anodization layer of the rail 302. The ability of the orientation tab to penetrate the anodization layer of the rail 302 provides for additional grounding pathways between the retention bracket 100 or similar element and the rail 302. This, in turn, improves the grounding of the system.

The retention bracket 100 may be made of a metal, and may be formed from, for example, sheet metal. In one example, the retention bracket 100 may be made by stamping the sheet metal to reflect the outer shape of the main body 102, the first aperture 108-1, the second aperture 108-2, the first orientation tab 110-1, and/or the second orientation tab 110-2. In the examples described herein, the retention brackets including the retention bracket 100 of FIG. 1 may include any number of orientation tabs. Portions of the retention bracket 100 may then be shaped through bending including bending the main body 102 into the u-shape including the base 106, the first leg 104-1 extending from the base 106, and the second leg 104-2 extending from the base 106. Further, the retention bracket 100 may be shaped by bending the first orientation tab 110-1 and the second orientation tab 110-2 downwards below the second leg 104-2. Still further, the retention bracket 100 may be shaped by bending the depression 114 and the flange 116. In one example, the retention bracket 100 may further be subjected to annealing, tempering, or other heat treatments to obtain a retention bracket 100 that is able to retain a spring bias as a user causes a wire to be affixed to the retention bracket 100 between the first leg 104-1 and the second leg 104-2 and may also be deformed (e.g., elastic deformation or plastic deformation) when a fastener is engaged through the first aperture 108-1 and the second aperture 108-2 and tightened against the first leg 104-1 and the second leg 104-2. In one example, the annealing, tempering, or other heat treatments may create a spring bias within the retention bracket 100 such that the first leg 104-1 and the second leg 104-2 resist deformation from the state depicted in FIG. 1. When a user seeks to insert a wire into the space between the first leg 104-1 and the second leg 104-2, the user may overcome the spring bias of the retention bracket 100 by pressing the ground wire past the depression 114 causing the distance between the first leg 104-1 and the second leg 104-2 to temporarily be enlarged. Once the ground wire passes the depression 114, the spring bias of the retention bracket 100 may cause the distance between the first leg 104-1 and the second leg 104-2 to return to a previous, non-enlarged state.

FIG. 2 illustrates a t-bolt 200 of a grounding lug system, according to an example of the principles described herein. The t-bolt 200 as mentioned above may include a head 202 perpendicularly connected to a shaft 204. The shaft 204 may include a number of threads 206 formed thereon to allow the shaft 204 to engage with a mating nut through the first aperture 108-1 and the second aperture 108-2 in order to secure the retention bracket 100 to a rail 302.

The head 202 may be used to clamp the retention bracket 100 to the rail 302 between the head 202 and the nut described above. The head 202 may include at least one ridge 208-1, 208-2, 208-3, 208-N (where N is any integer greater than or equal to 1 (collectively referred to herein as ridge(s) 208 unless specifically addressed otherwise)) formed on an underside of the head 202 closest to the shaft 204. The ridges 208 may assist in creating an electrical grounding path between the retention bracket 100 (being connected to ground wire(s)) and the rail to which the retention bracket 100 is connected. In one example, the ridges 208 may be deformed and/or may deform a portion of the rail when engaged with the rail to break through any coatings or oxidation layers present on the rail 302 and, therefore, ensure that the grounding path is created between the t-bolt 200 and the rail 302. A width of the head 202 of the t-bolt 200 may be narrow enough to fit within a channel 304 of the rail 302 and wide enough to restrict the ability of the t-bolt 200 to rotate within the channel 304 of the rail 302.

With the description of the retention bracket 100 and the t-bolt 200 above, FIG. 3 illustrates a side view of the grounding lug system 300 including the retention bracket 100 of FIG. 1 and the t-bolt 200 of FIG. 2, according to an example of the principles described herein. The rail 302 may include any rail used to directly or indirectly couple, for example, solar panel arrays and/or associated equipment to a mounting surface. The rail may include a channel 304 that runs along a length of the rail to allow for the retention bracket 100 to be connected to the rail 302 to create the grounding lug system 300. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 100 may be engaged with the shaft 204 via the first aperture 108-1 and the second aperture 108-2. In this manner, the second leg 104-2 extending from the base 106 of the main body 102 of the retention bracket 100 may be seated on and secured to a top surface of the rail 302.

In one example, an assembly including the retention bracket 100 assembled to the t-bolt 200 and nut 306 at least partially threaded on the t-bolt 200 may be created. As an assembly or as assembled, the retention bracket 100, t-bolt 200, and nut 306 may be coupled to the rail 302 by inserting the head 202 of the t-bolt 200 into a channel 304 of the rail 302. In one example, a light duty thread locking substance may be applied to the nut 306 to create friction between the nut 306 and the shaft 204 of the t-bolt. In this state, the head 202 of the t-bolt 200 may be inserted into the channel 304 of the rail 302 by the user gripping the nut 306 and aligning the head 202 with orientation tab(s) 110 so that head 202 and the orientation tab(s) 100 may be inserted into the channel 304. The head 202 of the t-bolt 200 may then be rotated in the channel 304 of the rail 302 by the user rotating the nut 306 in their fingers. In this manner, a more convenient and simple way of installing the retention bracket 100 may be achieved.

Further, the first orientation tab 110-1 and the second orientation tab 110-2 may extend down into the channel 304 of the rail 302 to ensure that the retention bracket 100 cannot rotate with respect to the rail 302. In this manner, the orientation of the retention bracket 100 may be maintained so that ground wire(s) 308 may be retained within the retention bracket 100 without bending the ground wire(s) 308 or causing the ground wire(s) 308 to divert from an intended path along the solar panel arrays or the rail. In the example of FIG. 3, the ground wire(s) 308 is connected to the retention bracket 100 and the retention bracket 100 is oriented with respect to the rail 302 such that the ground wire(s) 308 is running perpendicular to the rail 302. However, as will be demonstrated in other examples, the retention bracket 100 may be configured to allow for the ground wire(s) 308 to run perpendicularly and/or parallel with the rail 302.

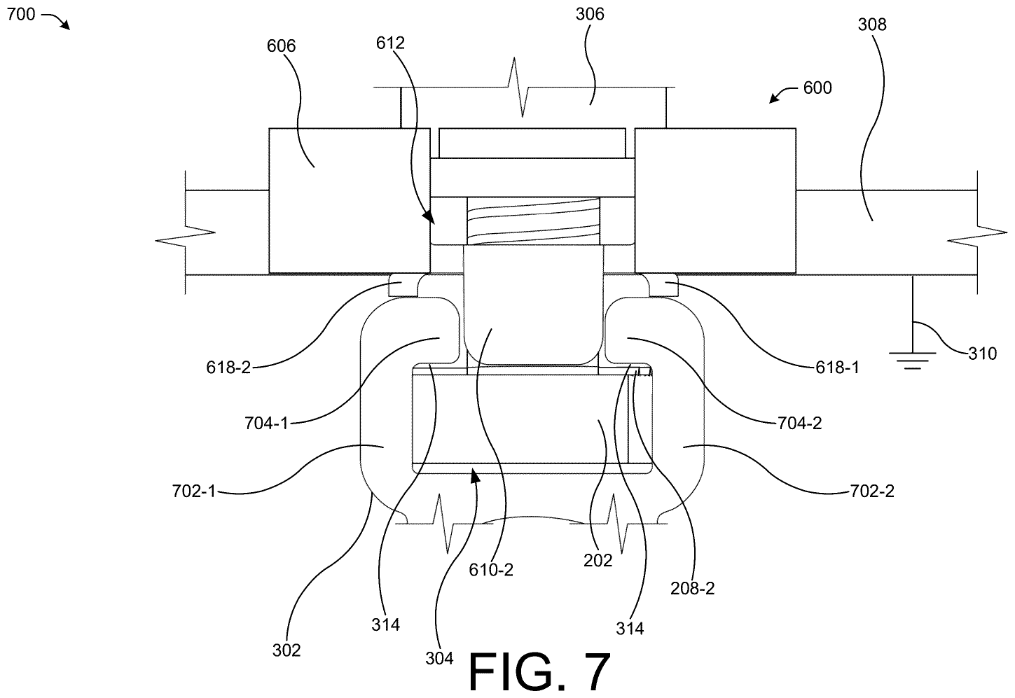

As depicted in FIG. 3, the first orientation tab 110-1 and the second orientation tab 110-2 are partially shown in ghost as they extend downward into the channel 304 of the rail 302. Further, also shown in ghost is the head 202 of the t-bolt 200 as engaged with an underside surface of the rail 302 that extends into the channel 304. For example, the head 202 of the t-bolt 200 may contact a bottom, interior portion of at least one return flange (e.g., the first return flange 704-1 and the second return flange 704-2 of FIG. 7) of the rail 302 or other underside surface 314 of the rail 302. The ridges 208 are depicted as engaging with the underside surface 314 of the rail 302. As mentioned above, the ridges 208 may be deformed and/or may deform the underside surface 314 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected via contact to the retention bracket 100 and/or the threads 206 of the shaft 204, and the electrical ground path may flow from the retention bracket 100 and/or the threads 206 of the shaft 204 to the head 202 of the t-bolt 200, through the ridges 208 and to the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc., are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the retention bracket 100 between the first leg 104-1 and the second leg 104-2 and interior to the depression 114 and the flange 116. At this position, the ground wire(s) 308 may be secured in the retention bracket 100 and the depression 114 may force the ground wire(s) 308 against the threads 206 of the shaft 204 of the t-bolt 200. In one example, the threads 206 may engage with the ground wire(s) 308 during installation and tightening of a nut 306 against the first leg 104-1 of the retention bracket 100. In this manner, the relatively softer metal (e.g., copper) of the ground wire(s) 308 may be deformed (e.g., elastic deformation or plastic deformation) by the threads 206 as the depression 114 forces the ground wire(s) 308 against the threads 206.

Further, in one example, the ground wire(s) 308 may be installed such that the ground wire(s) 308 abuts the base 106 of the retention bracket 100 and is seated in a void 312 created between the base 106 and the threads 206 of the shaft 204 of the t-bolt 200. In this example, the user may insert the ground wire(s) 308 into the retention bracket 100 such that the ground wire(s) 308 is seated against the base 106. The user may then seat the retention bracket 100 into an engaged state with the rail 302 as depicted in FIG. 3 and cause the t-bolt 200 to extend through the first aperture 108-1 and the second aperture 108-2 such that the ground wire(s) 308 remains abutted with the base 106. In this manner, one or more ground wire(s) 308 may be connected to the retention bracket 100. A plurality of grounding lug systems 300 including the retention bracket 100 and the t-bolt 200 may be used to secure the ground wire(s) 308 along a length of the rail 302.

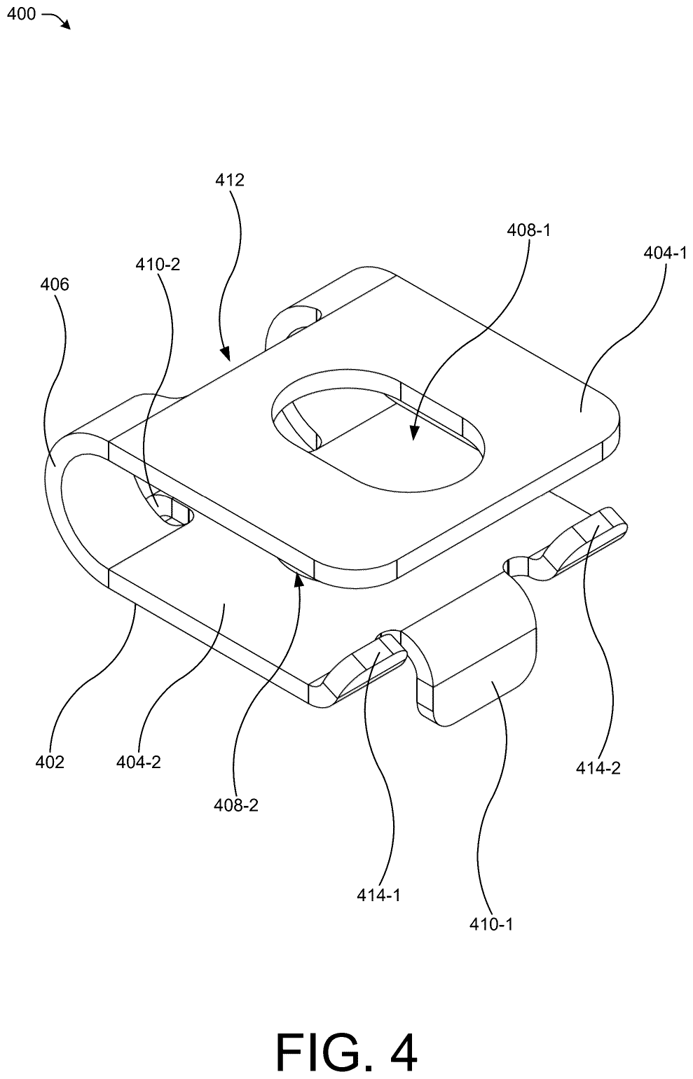

The various elements and features of the retention bracket 100, the t-bolt 200, and the grounding lug system 300 of FIGS. 1 through 3 may be included within other examples described herein. With this understanding, additional examples of retention brackets, t-bolts, and grounding lug systems will now be described in connection with FIGS. 4 through 34.

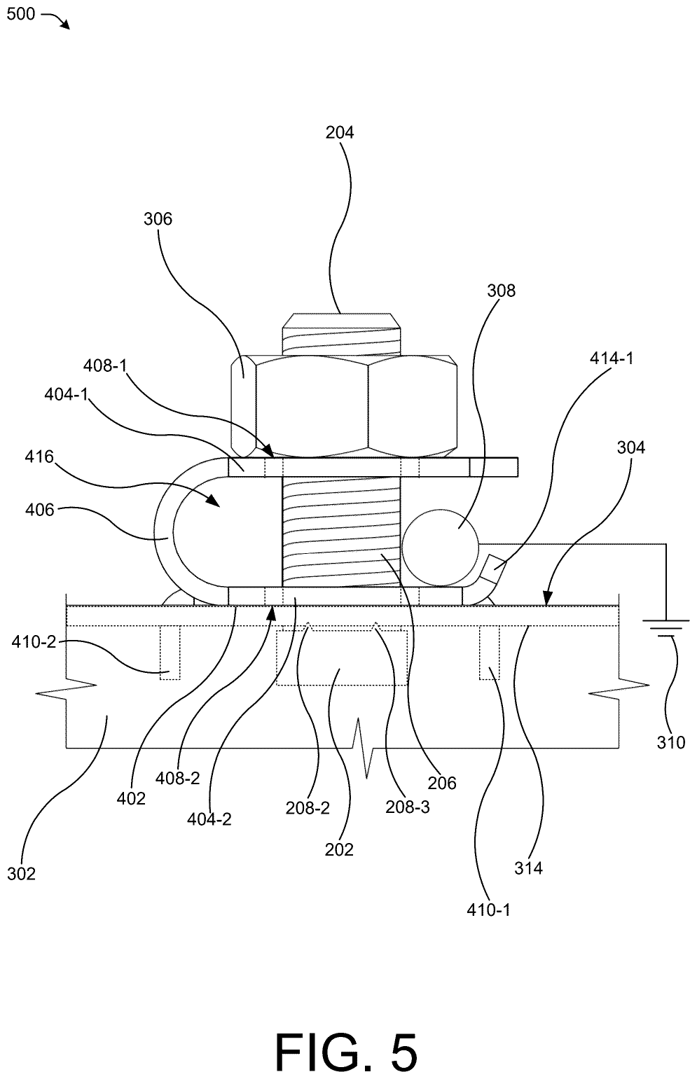

FIG. 4 illustrates a retention bracket 400 of a grounding lug system, according to an example of the principles described herein. FIG. 5 illustrates a grounding lug system 500 including the retention bracket 400 of FIG. 4 and the t-bolt 200 of FIG. 2, according to an example of the principles described herein. The retention bracket 400 may include a main body 402 having a u-shaped cross-section including a base 406, a first leg 404-1 extending from the base 406, and a second leg 404-2 extending from the base 406. The distance between the first leg 404-1 and the second leg 404-2 may be large enough to accommodate ground wires of various gauges.

The first leg 404-1 may include a first aperture 408-1 defined therein. Similarly, the second leg 404-2 may include a second aperture 408-2 defined therein. The first aperture 408-1 and the second aperture 408-2 may accommodate for the t-bolt 200 of FIG. 2 to extend through the retention bracket 400 and connect the retention bracket 400 to a rail 302. The first aperture 408-1 and the second aperture 408-2 may have an oval shape to allow for the first aperture 408-1 to move with respect to the second aperture 408-2 when the t-bolt 200 is used to connect the retention bracket 400 to the rail 302 and clamp the ground wire(s) 308 between the first leg 404-1 and the second leg 404-2.

The retention bracket 400 may further include a first flange 414-1 and a second flange 414-2 extending from the second leg 404-2. The first flange 414-1 and the second flange 414-2 may extend into the space between the first leg 404-1 and the second leg 404-2. In this manner, the first flange 414-1 and the second flange 414-2 serve to retain any wires (e.g., the ground wire(s) 308) that are introduced into the space between the first leg 404-1 and the second leg 404-2.

The retention bracket 400 may further include an aperture 412 defined in the base 406. Further, a first orientation tab 410-1 and a second orientation tab 410-2 may extend from the second leg 404-2 and turn downwards below the second leg 404-2. In one example, the second orientation tab 410-2 may be formed by cutting the second orientation tab 410-2 from the base 406 and bending the second orientation tab 410-2 to extend from the second leg 404-2 and turn downwards below the second leg 404-2 and in order to form the aperture 412.

The first orientation tab 410-1 and the second orientation tab 410-2 may be used to retain the retention bracket 400 in a desired orientation with respect to a rail 302 to which the retention bracket 400 may be connected. For example, the first orientation tab 410-1 and the second orientation tab 410-2 may extend into a channel 304 of a rail 302 as depicted in FIG. 5 and other figures that depict a rail 302 with retention brackets that include an orientation tab.

The retention bracket 400 may be made of a metal, and may be formed from, for example, sheet metal. In one example, the retention bracket 400 may be made by stamping the sheet metal to reflect the outer shape of the main body 402, the first aperture 408-1, the second aperture 408-2, the first orientation tab 410-1, and the second orientation tab 410-2. Portions of the retention bracket 400 may then be shaped through bending including bending the main body 402 into the u-shape including the base 406, the first leg 404-1 extending from the base 406, and the second leg 404-2 extending from the base 406. Further, the retention bracket 400 may be shaped by bending the first orientation tab 410-1 and the second orientation tab 410-2 downwards below the second leg 404-2. Still further, the retention bracket 400 may be shaped by bending the first flange 414-1 and the second flange 414-2. In one example, the retention bracket 400 may further be subjected to annealing, tempering, or other heat treatments to obtain a retention bracket 400 that is able to retain a spring bias as a user causes a wire to be affixed to the retention bracket 400 between the first leg 404-1 and the second leg 404-2 and may also be deformed (e.g., elastic deformation or plastic deformation) when a fastener is engaged through the first aperture 408-1 and the second aperture 408-2 and tightened against the first leg 404-1 and the second leg 404-2.

With reference to FIGS. 2 and 5 a t-bolt 200 of a grounding lug system 500 may be utilized to secure the retention bracket 400 to the rail 302. The t-bolt 200 as mentioned above may include a head 202 perpendicularly connected to a shaft 204. The shaft 204 may include a number of threads 206 formed thereon to allow the shaft 204 to engage with a mating nut 306 through the first aperture 408-1 and the second aperture 408-2 in order to secure the retention bracket 400 to a rail 302.

The head 202 may be used to clamp the retention bracket 400 to the rail 302 between the head 202 and the nut 306 and may include the ridges 208 formed on an underside of the head 202 closest to the shaft 204 to assist in creating an electrical grounding path between the retention bracket 400 and the rail 302. In one example, the ridges 208 may be deformed and/or may deform a portion of the rail when engaged with the rail to break through any coatings or oxidation layers present on the rail 302 and, therefore, ensure that the grounding path is created between the t-bolt 200 and the rail 302 is created. A width of the head 202 of the t-bolt 200 may be narrow enough to fit within a channel 304 of the rail 302 and wide enough to restrict the ability of the t-bolt 200 to rotate within the channel 304 of the rail 302.

With the description of the retention bracket 400 and the t-bolt 200 above, FIG. 5 illustrates a side view of the grounding lug system 500 including the retention bracket 400 of FIG. 4 and the t-bolt 200 of FIG. 2, according to an example of the principles described herein. The rail 302 may include a channel 304 that runs along a length of the rail 302 to allow for the retention bracket 400 to be connected to the rail 302 to create the grounding lug system 500. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 400 may be engaged with the shaft 204 via the first aperture 408-1 and the second aperture 408-2. In this manner, the second leg 404-2 extending from the base 406 of the main body 402 of the retention bracket 400 may be seated on and secured to a top surface of the rail 302.

Further, the first orientation tab 410-1 and the second orientation tab 410-2 may extend down into the channel 304 of the rail 302 to ensure that the retention bracket 400 cannot rotate with respect to the rail 302. In this manner, the orientation of the retention bracket 400 may be maintained so that the ground wire(s) 308 may be retained within the retention bracket 400 without bending the ground wire(s) 308 or causing the ground wire(s) 308 to divert from an intended path along the solar panel arrays or the rail 302. In the example of FIG. 5, the ground wire(s) 308 is connected to the retention bracket 400 and the retention bracket 400 is oriented with respect to the rail 302 such that the ground wire(s) 308 is running perpendicular to the rail 302. However, as will be demonstrated in other examples, the retention bracket 400 may be configured to allow for the ground wire(s) 308 to run perpendicularly and/or parallel with the rail 302.

As depicted in FIG. 5, the first orientation tab 410-1 and the second orientation tab 410-2 are partially shown in ghost as they extend downward into the channel 304 of the rail 302. Further, also shown in ghost is the head 202 of the t-bolt 200 as engaged with an underside surface of the rail 302 that extends into the channel 304. The ridges 208 are depicted as engaging with the underside surface 314 of the rail 302. As mentioned above, the ridges 208 may be deformed and/or may deform the underside surface 314 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 400 and/or the threads 206 of the shaft 204, and the electrical ground path may flow from the retention bracket 400 and/or the threads 206 of the shaft 204 to the head 202 of the t-bolt 200, through the ridges 208 and to the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc, are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the retention bracket 400 between the first leg 404-1 and the second leg 404-2 and interior to the first flange 414-1 and the second flange 414-2. At this position, the ground wire(s) 308 may be secured in the retention bracket 400 and the first flange 414-1 and the second flange 414-2 may force the ground wire(s) 308 against the threads 206 of the shaft 204 of the t-bolt 200. In one example, the threads 206 may engage with the ground wire(s) 308 during installation and tightening of a nut 306 against the first leg 404-1 of the retention bracket 400. In this manner, the relatively softer metal (e.g., copper) of the ground wire(s) 308 may be deformed (e.g., elastic deformation or plastic deformation) by the threads 206 as the first flange 414-1 and the second flange 414-2 force the ground wire(s) 308 against the threads 206.

Further, in one example, the ground wire(s) 308 may be installed such that the ground wire(s) 308 abuts the base 406 of the retention bracket 400 and is seated in a void 416 created between the base 406 and the threads 206 of the shaft 204 of the t-bolt 200. In this example, the user may insert the ground wire(s) 308 into the retention bracket 400 such that the ground wire(s) 308 is seated against the base 406. The user may then seat the retention bracket 400 into an engaged state with the rail 302 as depicted in FIG. 3 and cause the t-bolt 200 to extend through the first aperture 408-1 and the second aperture 408-2 such that the ground wire(s) 308 remains abutted with the base 406. In this manner, one or more ground wire(s) 308 may be connected to the retention bracket 400. A plurality of grounding lug systems 500 including the retention bracket 400 and the t-bolt 200 may be used to secure the ground wire(s) 308 along a length of the rail 302.

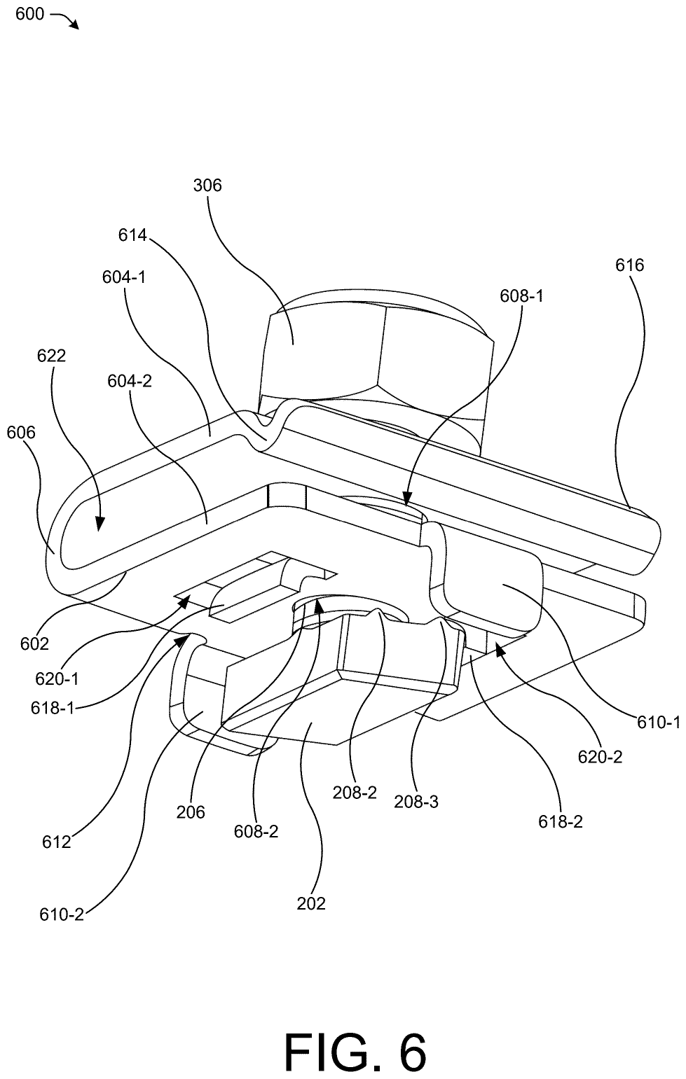

FIG. 6 illustrates a retention bracket 600 and the t-bolt 200 of FIG. 2, according to an example of the principles described herein. FIG. 7 illustrates a grounding lug system 700 including the retention bracket 600 of FIG. 6 as connected with a rail 302, according to an example of the principles described herein. The retention bracket 600 may include a main body 602 having a u-shaped cross-section including a base 606, a first leg 604-1 extending from the base 606, and a second leg 604-2 extending from the base 606. The distance between the first leg 604-1 and the second leg 604-2 may be large enough to accommodate ground wires of various gauges.

The first leg 604-1 may include a first aperture 608-1 defined therein. Similarly, the second leg 604-2 may include a second aperture 608-2 defined therein. The first aperture 608-1 and the second aperture 608-2 may accommodate for the t-bolt 200 of FIG. 2 to extend through the retention bracket 600 and connect the retention bracket 600 to the rail 302. The first aperture 608-1 and the second aperture 608-2 may have an oval shape to allow for the first aperture 608-1 to move with respect to the second aperture 608-2 when the t-bolt 200 is used to connect the retention bracket 600 to the rail 302 and clamp the ground wire(s) 308 between the first leg 604-1 and the second leg 604-2.

The retention bracket 600 may further include a depression 614 extending from the first leg 604-1 and a flange 616 extending from the depression 614. The depression 614 extends into the space between the first leg 604-1 and the second leg 604-2, and the flange 616 extends away from the space between the first leg 604-1 and the second leg 604-2. In this manner, the depression 614 and the flange 616 serve to retain any wires (e.g., the ground wire(s) 308) that are introduced into the space between the first leg 604-1 and the second leg 604-2.

The retention bracket 600 may further include an aperture 612 defined in the base 606. Further, a first orientation tab 610-1 and a second orientation tab 610-2 may extend from the second leg 604-2 and turn downwards below the second leg 604-2. In one example, the second orientation tab 610-2 may be formed by cutting the second orientation tab 610-2 from the base 606 and bending the second orientation tab 610-2 to extend from the second leg 604-2 and turn downwards below the second leg 604-2 and in order to form the aperture 612.

The first orientation tab 610-1 and the second orientation tab 610-2 may be used to retain the retention bracket 600 in a desired orientation with respect to a rail 302 to which the retention bracket 600 may be connected. For example, the first orientation tab 610-1 and the second orientation tab 610-2 may extend into a channel 304 of a rail 302 as depicted in FIG. 7 and other figures that depict a rail 302 with retention brackets that include an orientation tab.

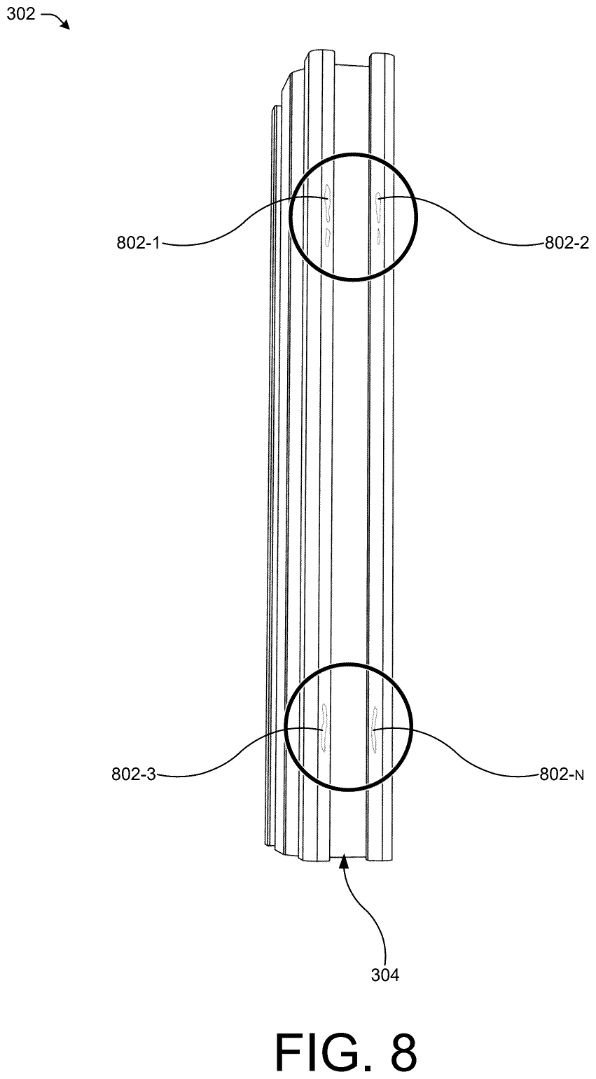

The retention bracket 600 may further include a first contact tab 618-1 and a second contact tab 618-2 extending from the bottom of the second leg 604-2. The extension of the first contact tab 618-1 and the second contact tab 618-2 creates a first contact tab void 620-1 and a second contact tab void 620-2 defined in the first leg 604-1 of the main body 602. As mentioned above, apart from managing the placement of the ground wire(s) 308 along a length of a solar panel array and ensuring the ground wire(s) 308 is secured to the solar panel array, the grounding lug system 700 (and other grounding lug systems described herein) may further serve as an electrical conduit for the ground wire(s) 308. The first contact tab 618-1 and the second contact tab 618-2 may be shaped, dimensioned, and bent to contact a portion of the rail 302. For example, the first contact tab 618-1 and the second contact tab 618-2 may contact a top, exterior portion of a first return flange 704-1 and a second return flange 704-2 that extend from a first leg 702-1 and a second leg 702-2 of the rail 302. FIG. 8 illustrates the rail 302 including markings 802-1, 802-2, 802-3, 802-N (where N is any integer greater than or equal to 1 (collectively referred to herein as marking(s) 802 unless specifically addressed otherwise)) created by the first contact tab 618-1 and the second contact tab 618-2 contacting the first return flange 704-1 and the second return flange 704-2 when the grounding lug system 700 of FIG. 6 is connected with the rail 302, according to an example of the principles described herein. As depicted in FIG. 8, the markings 802 indicate a position where two separate grounding lug systems 600 have been connected to the rail 302. The markings 802 indicate that the first contact tab 618-1 and the second contact tab 618-2, when securely connected to the first return flange 704-1 and the second return flange 704-2 of the rail 302, may deform or cut into the material of the rail 302. Further, the first contact tab 618-1 and the second contact tab 618-2 may, in this manner, cut through any oxidation, paint, or other layers that may coat the rail 302. This ensures that the electrical path for the ground wire(s) 308 may successfully travel from the grounding lug system 700, to the rail 302, and onto ground 310.

The retention bracket 600 may be made of a metal, and may be formed from, for example, sheet metal. In one example, the retention bracket 600 may be made by stamping the sheet metal to reflect the outer shape of the main body 602, the first aperture 608-1, the second aperture 608-2, the first orientation tab 610-1, the second orientation tab 610-2, first contact tab 618-1, and the second contact tab 618-2. Portions of the retention bracket 600 may then be shaped through bending including bending the main body 602 into the u-shape including the base 606, the first leg 604-1 extending from the base 606, and the second leg 604-2 extending from the base 606. Further, the retention bracket 600 may be shaped by bending the first orientation tab 610-1 and the second orientation tab 610-2 downwards below the second leg 604-2, and by bending the first contact tab 618-1, and the second contact tab 618-2. Still further, the retention bracket 600 may be shaped by bending the depression 414 and the flange 416. In one example, the retention bracket 600 may further be subjected to annealing, tempering, or other heat treatments to obtain a retention bracket 600 that is able to retain a spring bias as a user causes a wire to be affixed to the retention bracket 600 between the first leg 604-1 and the second leg 604-2 and may also be deformed (e.g., elastic deformation or plastic deformation) when a fastener is engaged through the first aperture 608-1 and the second aperture 608-2 and tightened against the first leg 604-1 and the second leg 604-2. In one example, the annealing, tempering, or other heat treatments may create a spring bias within the retention bracket 600 such that the first leg 604-1 and the second leg 604-2 resist deformation from the state depicted in FIG. 6. When a user seeks to insert a wire into the space between the first leg 604-1 and the second leg 604-2, the user may overcome the spring bias of the retention bracket 600 by pressing the ground wire past the depression 614 causing the distance between the first leg 604-1 and the second leg 604-2 to temporarily be enlarged. Once the ground wire passes the depression 614, the spring bias of the retention bracket 600 may cause the distance between the first leg 604-1 and the second leg 604-2 to return flange to a previous, non-enlarged state.

With reference to FIGS. 6 and 7 the t-bolt 200 of the grounding lug system 700 may be utilized to secure the retention bracket 600 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the first aperture 608-1 and the second aperture 608-2 in order to secure the retention bracket 600 to a rail 302.

The head 202 may be used to clamp the retention bracket 600 to the rail 302 between the head 202 and the nut 306 and may include the ridges 208 formed on an underside of the head 202 closest to the shaft 204 to assist in creating an electrical grounding path between the retention bracket 600 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

With the description of the retention bracket 600 and the t-bolt 200 above, FIG. 7 illustrates an side view of the grounding lug system 700 including the retention bracket 600 of FIG. 6 and the t-bolt 200 as viewed from the end of the retention bracket 600 including the aperture 612. The rail 302 may include a channel 304 that runs along a length of the rail 302 to allow for the retention bracket 600 to be connected to the rail 302 to create the grounding lug system 700. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 600 may be engaged with the shaft 204 via the first aperture 608-1 and the second aperture 608-2. In this manner, the second leg 604-2 extending from the base 606 of the main body 602 of the retention bracket 600 may be seated on and secured to a top surface of the rail 302.

Further, the first orientation tab 610-1 and the second orientation tab 610-2 may extend down into the channel 304 of the rail 302 to ensure that the retention bracket 600 cannot rotate with respect to the rail 302. In this manner, the orientation of the retention bracket 600 may be maintained so that the ground wire(s) 308 may be retained within the retention bracket 600 without bending the ground wire(s) 308 or causing the ground wire(s) 308 to divert from an intended path along the solar panel arrays or the rail 302. In the example of FIGS. 6 and 7, the ground wire(s) 308 is connected to the retention bracket 600 and the retention bracket 600 is oriented with respect to the rail 302 such that the ground wire(s) 308 is running perpendicular to the rail 302. However, as will be demonstrated in other examples, the retention bracket 600 may be configured to allow for the ground wire(s) 308 to run perpendicularly and/or parallel with the rail 302.

As depicted in FIG. 7, the second orientation tab 610-2 is depicted as it extends downward into the channel 304 of the rail 302. The first orientation tab 610-1 may similarly extend into the channel 304 on an opposite side of the retention bracket 600 as the side of the retention bracket 600 depicted in FIG. 7. Further, the head 202 of the t-bolt 200 is depicted as engaged with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 are depicted as engaging with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 600 and/or the threads 206 of the shaft 204, and the electrical ground path may flow from the retention bracket 600 and/or the threads 206 of the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc, are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the retention bracket 600 between the first leg 604-1 and the second leg 604-2 and interior to the depression 614. At this position, the ground wire(s) 308 may be secured in the retention bracket 600 and the depression 614 may force the ground wire(s) 308 against the threads 206 of the shaft 204 of the t-bolt 200. In one example, the threads 206 may engage with the ground wire(s) 308 during installation and tightening of the nut 306 against the first leg 604-1 of the retention bracket 600. In this manner, the relatively softer metal (e.g., copper) of the ground wire(s) 308 may be deformed (e.g., elastic deformation or plastic deformation) by the threads 206 as the depression 614 forces the ground wire(s) 308 against the threads 206.

Further, in one example, the ground wire(s) 308 may be installed such that the ground wire(s) 308 abuts the base 606 of the retention bracket 600 and is seated in a void 622 created between the base 606 and the threads 206 of the shaft 204 of the t-bolt 200. In this example, the user may insert the ground wire(s) 308 into the retention bracket 600 such that the ground wire(s) 308 is seated against the base 606. The user may then seat the retention bracket 600 into an engaged state with the rail 302 as depicted in FIG. 7 and cause the t-bolt 200 to extend through the first aperture 608-1 and the second aperture 608-2 such that the ground wire(s) 308 remains abutted with the base 606. In this manner, one or more ground wire(s) 308 may be connected to the retention bracket 600 with a second ground wire(s) 308 being seated between the t-bolt 200 and the depression 614 as described above. A plurality of grounding lug systems 700 including the retention bracket 600 and the t-bolt 200 may be used to secure the ground wire(s) 308 along a length of the rail 302.

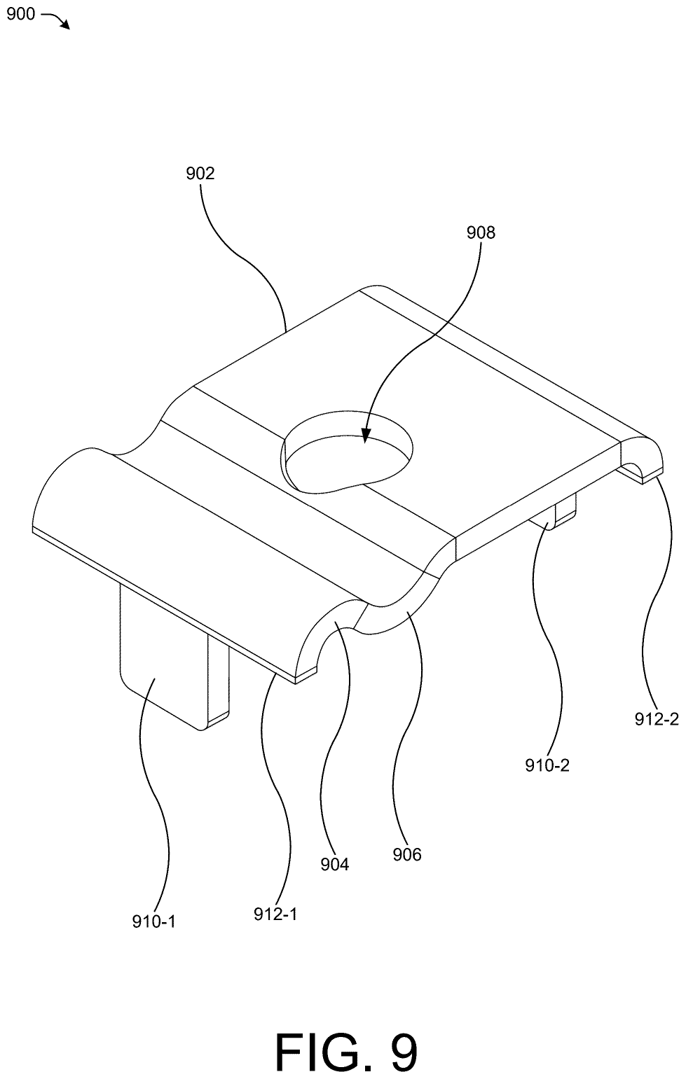

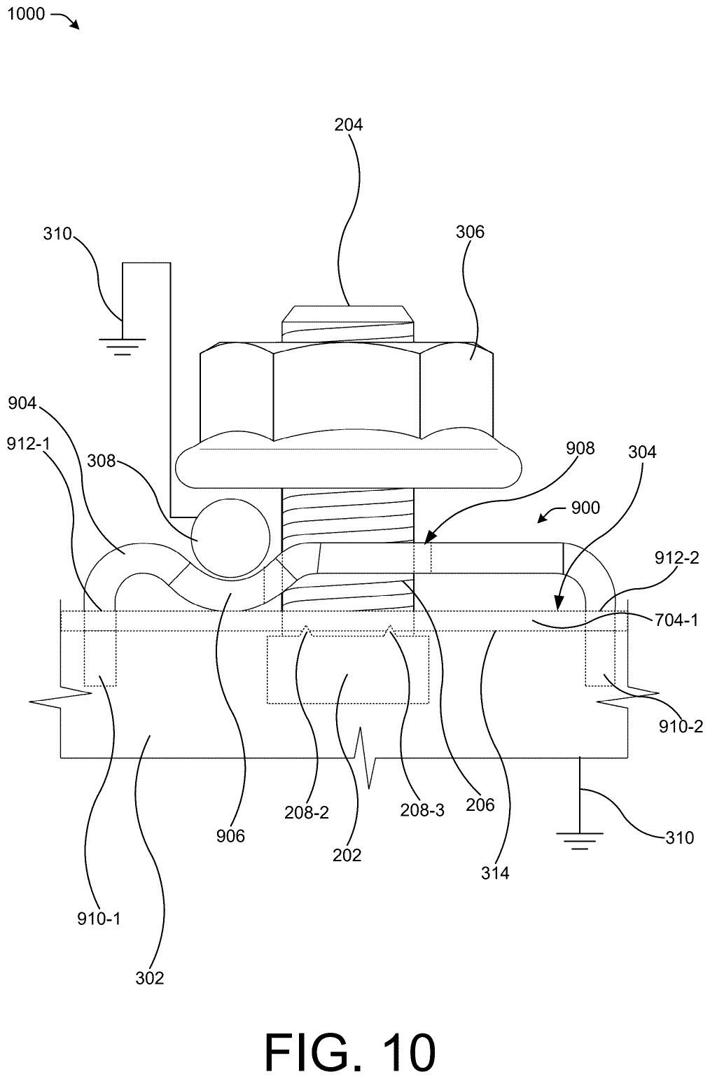

FIG. 9 illustrates a retention bracket 900 of a grounding lug system 1000, according to an example of the principles described herein. FIG. 10 illustrates the retention bracket 900 of FIG. 9 incorporated with the grounding lug system 1000 and connected with a rail 302, according to an example of the principles described herein. The retention bracket 900 may include a main body 902, a depression 906 extending below the main body 902, a protrusion 904 extending upwards from the depression 906 and/or above the main body 902, a first terminus 912-1 terminating at an end of the first protrusion 912-1, and a second terminus 912-2 extending downwards from the main body 902 at an end of the main body 902 opposite the protrusion 904 and the depression 906. The depression 906 may function as a position along a length of the main body 902 of the retention bracket 900 at which the ground wire(s) 308 may be seated and may be dimensioned to accommodate ground wires of various gauges.

The main body 902 may include an aperture 908 defined therein. The aperture 908 may accommodate for the t-bolt 200 of FIG. 2 to extend through the retention bracket 900 and connect the retention bracket 900 to the rail 302. In one example, the aperture 908 may include a circular shape to accommodate for the shaft 204 of the t-bolt 200 when the t-bolt 200 is used to connect the retention bracket 900 to the rail 302 and clamp the ground wire(s) 308 between the nut 306 and the retention bracket 900.

The retention bracket 900 may further include the depression 906 extending from the main body 902 and protrusion 904 extending upwards from the depression 906 and/or above the main body 902. In this manner, the depression 906 and the protrusion 904 serve to retain any wires (e.g., the ground wire(s) 308) that are introduced into the space between the retention bracket 900 and the nut 306. In other words, the nut 306 serves as the element that secures the ground wire(s) 308 to the retention bracket 900.

The retention bracket 900 may further include an aperture 908 defined in the base 902. Further, a first orientation tab 910-1 and a second orientation tab 910-2 may extend from the main body 902 and turn downwards below the main body 902. As in other example retention brackets described herein, the first orientation tab 910-1 and the second orientation tab 910-2 may be used to retain the retention bracket 900 in a desired orientation with respect to the rail 302 to which the retention bracket 900 may be connected. For example, the first orientation tab 910-1 and the second orientation tab 910-2 may extend into a channel 304 of a rail 302 as depicted in FIG. 10 and other figures that depict a rail 302 with retention brackets that include an orientation tab.

The retention bracket 900 may further include a first terminus 912-1 and a second terminus 912-2. The first terminus 912-1 may extend from an end of the protrusion 904 and the second terminus 912-2 may extend downwards from the main body 902 at an end of the main body 902 opposite the protrusion 904 and the depression 906. As mentioned above, apart from managing the placement of the ground wire(s) 308 along a length of a solar panel array and ensuring the ground wire(s) 308 is secured to the solar panel array, the grounding lug system 1000 (and other grounding lug systems described herein) may further serve as an electrical conduit for the ground wire(s) 308. The first terminus 912-1 and the second terminus 912-2 may be shaped, dimensioned, and bent to contact a portion of the rail 302. For example, the first terminus 912-1 and the second terminus 912-2 may contact a top, exterior portion of the first return flange 704-1 and the second return flange 704-2 that extend from a first leg 702-1 and a second leg 702-2 of the rail 302. As similarly depicted in FIG. 8, the first terminus 912-1 and the second terminus 912-2 may create markings on the rail similar to markings 802 created by the first contact tab 618-1 and the second contact tab 618-2 contacting the first return flange 704-1 and the second return flange 704-2 when the grounding lug system 1000 of FIG. 10 is connected with the rail 302. As depicted in FIG. 8, the markings 802 indicate a position where two separate grounding lug systems 1000 have been connected to the rail 302. The markings 802 indicate that the first terminus 912-1 and the second terminus 912-2, when securely connected to the first return flange 704-1 and the second return flange 704-2 of the rail 302, may deform or cut into the material of the rail 302. Further, the first terminus 912-1 and the second terminus 912-2 may, in this manner, cut through any oxidation, paint, or other layers that may coat the rail 302. This ensures that the electrical conduit for the ground wire(s) 308 may successfully travel from the grounding lug system 1000, to the rail 302, and onto ground 310.

The retention bracket 900 may be made of a metal, and may be formed from, for example, sheet metal. In one example, the retention bracket 900 may be made by stamping the sheet metal to reflect the outer shape of the main body 902, the aperture 908, the first orientation tab 910-1, the second orientation tab 910-2, first terminus 912-1, and the second terminus 912-2. Portions of the retention bracket 900 may then be shaped through bending including bending the main body 902. Further, the retention bracket 900 may be shaped by bending the first orientation tab 910-1 and the second orientation tab 910-2 downwards, shaping the depression 906 and the protrusion 904, and by bending the first terminus 912-1, and the second terminus 912-2. In one example, the retention bracket 900 may further be subjected to annealing, tempering, or other heat treatments to obtain a retention bracket 900 that is able to resist deformation from the state depicted in FIGS. 9 and 10.

With reference to FIGS. 9 and 10, the t-bolt 200 of the grounding lug system 1000 may be utilized to secure the retention bracket 900 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the aperture 908 in order to secure the retention bracket 900 to the rail 302.

The head 202 may be used to clamp the retention bracket 900 to the rail 302 between the head 202 and the nut 306 and may include the ridges 208 formed on an underside of the head 202 closest to the shaft 204 to assist in creating an electrical grounding path between the retention bracket 900 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

With the description of the retention bracket 900 and the t-bolt 200 above, FIG. 10 illustrates an side view of the grounding lug system 1000 including the retention bracket 900 of FIG. 9 and the t-bolt 200 as viewed from a side of the retention bracket 900. The rail 302 may include a channel 304 that runs along a length of the rail 302 to allow for the retention bracket 900 to be connected to the rail 302 to create the grounding lug system 1000. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 900 may be engaged with the shaft 204 via the aperture 908. In this manner, the main body 902 of the retention bracket 900 may be seated on and secured to a top surface of the rail 302.

Further, the first orientation tab 910-1 and the second orientation tab 910-2 may extend down into the channel 304 of the rail 302 to ensure that the retention bracket 900 cannot rotate with respect to the rail 302. In this manner, the orientation of the retention bracket 900 may be maintained so that the ground wire(s) 308 may be retained within the retention bracket 900 without bending the ground wire(s) 308 or causing the ground wire(s) 308 to divert from an intended path along the solar panel arrays or the rail 302. In the example of FIGS. 9 and 10, the ground wire(s) 308 is connected to the retention bracket 900 and the retention bracket 900 is oriented with respect to the rail 302 such that the ground wire(s) 308 is running perpendicular to the rail 302. However, as will be demonstrated in other examples, the retention bracket 900 may be configured to allow for the ground wire(s) 308 to run perpendicularly and/or parallel with the rail 302.

As depicted in FIG. 10, the second orientation tab 910-2 is depicted as it extends downward into the channel 304 of the rail 302. Further, the head 202 of the t-bolt 200 is depicted as engaged with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 are depicted as engaging with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 900 and/or the threads 206 of the shaft 204, or the nut 306, and the electrical ground path may flow from the retention bracket 900 and/or the threads 206 of the shaft 204 or a surface of the nut facing toward the rail to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc, are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the depression 906 of the retention bracket 900. Further, as depicted in FIG. 9, the aperture 908 may be defined in the main body 902 and at least a portion of the depression 906. At this position, the ground wire(s) 308 may be secured in the retention bracket 900 via the nut 306, and the depression 906 may be positioned along a length of the main body 902 to force the ground wire(s) 308 against the threads 206 of the shaft 204 of the t-bolt 200 since the aperture 908 encroaches into the depression 906. In one example, the threads 206 may engage with the ground wire(s) 308 during installation and tightening of the nut 306 against the ground wire(s) 308 and the retention bracket 900. In this manner, the relatively softer metal (e.g., copper) of the ground wire(s) 308 may be deformed (e.g., elastic deformation or plastic deformation) by the threads 206 as the depression 906 and the shaft 204 engaged with the aperture 908 forces the ground wire(s) 308 against the threads 206.

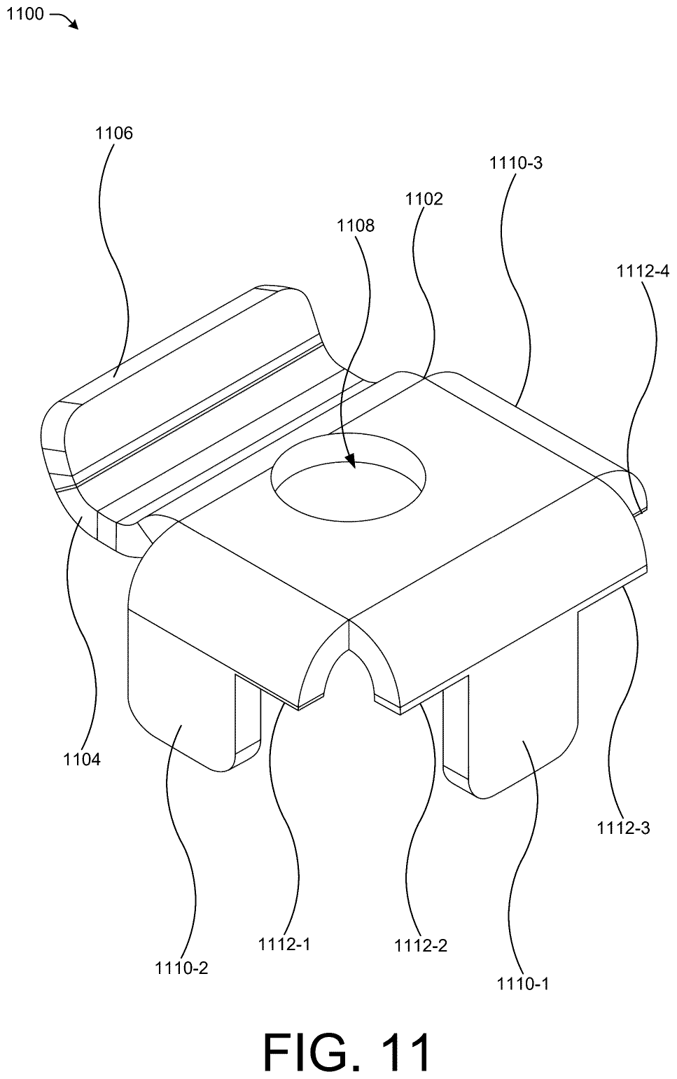

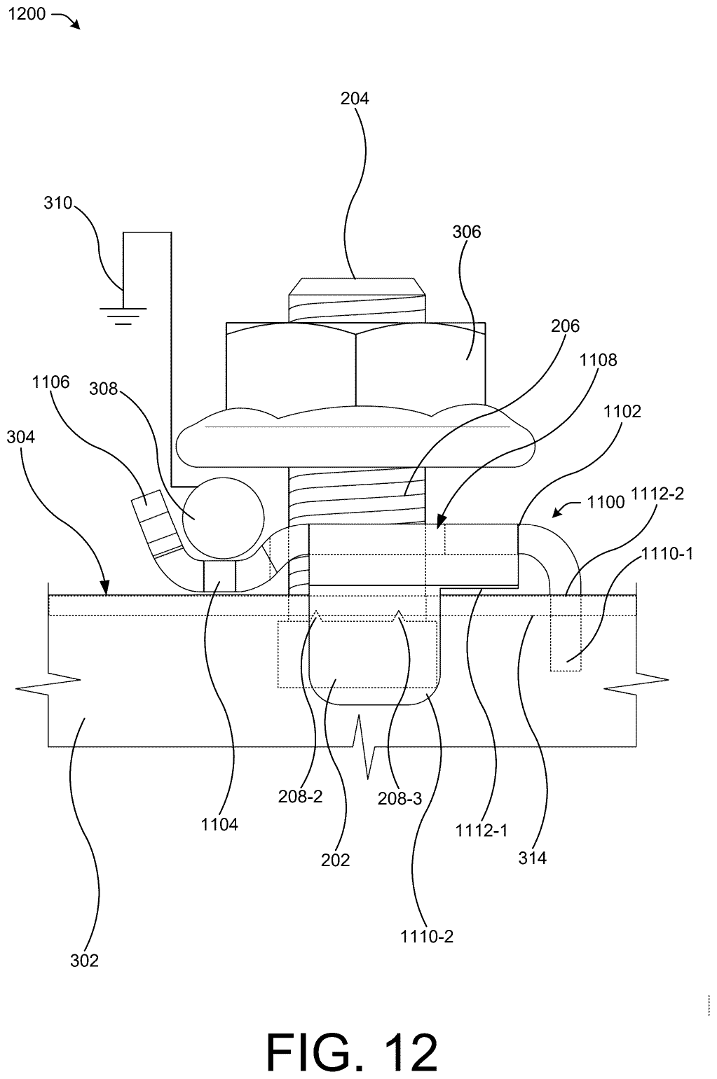

FIG. 11 illustrates a retention bracket 1100 of a grounding lug system 1200, according to an example of the principles described herein. FIG. 12 illustrates the retention bracket 1100 of FIG. 11 incorporated with the grounding lug system 1200 and connected with a rail 302, according to an example of the principles described herein. The retention bracket 1100 may include a main body 1102, a depression 1104 extending below the main body 1102, and a flange 1106 extending upwards from the depression 1104 and/or above the main body 1102. The retention bracket 1100 may further include a plurality of termini 1112-1, 1112-2, 1112-3, 1112-N (where N is any integer greater than or equal to 1 (collectively referred to herein as terminus or termini 1112 unless specifically addressed otherwise)) including, by name, a first terminus 1112-1, a second terminus 1112-2, a third terminus 1112-3, and a fourth terminus 1112-4 that terminating at downturned edges of the main body 1102. The depression 1104 may function as a position along a length of the main body 1102 of the retention bracket 1100 at which the ground wire(s) 308 may be seated and may be dimensioned to accommodate ground wires of various gauges.

The main body 1102 may include an aperture 1108 defined therein. The aperture 1108 may accommodate for the t-bolt 200 of FIG. 2 to extend through the retention bracket 1100 and connect the retention bracket 1100 to the rail 302. In one example, the aperture 1108 may include a circular shape to accommodate for the shaft 204 of the t-bolt 200 to ensure that the retention bracket 1100 does not move with respect to the rail 302 when the t-bolt 200 is used to connect the retention bracket 1100 to the rail 302 and clamp the ground wire(s) 308 between the nut 306 and the retention bracket 1100.

The retention bracket 1100 may further include the depression 1104 extending from the main body 1102 and flange 1106 extending upwards from the depression 1104 and/or above the main body 1102. In this manner, the depression 1104 and the flange 1106 serve to retain any wires (e.g., the ground wire(s) 308) that are introduced into the space between the retention bracket 1100 and the nut 306. In other words, the nut 306 serves as the element that secures the ground wire(s) 308 to the retention bracket 1100.

The retention bracket 1100 may further include a first orientation tab 1110-1, a second orientation tab 1110-2, and a third orientation tab 1110-3 (a major portion of which is not depicted in FIGS. 11 and 12). The first orientation tab 1110-1, the second orientation tab 1110-2, and the third orientation tab 1110-3 may extend from the main body 1102 and turn downwards below the main body 1102. As in other example retention brackets described herein, the first orientation tab 1110-1, the second orientation tab 1110-2, and the third orientation tab 1110-3 may be used to retain the retention bracket 1100 in a desired orientation with respect to the rail 302 to which the retention bracket 1100 may be connected. For example, in a first orientation depicted in FIG. 12, the first orientation tab 1110-1 may extend into the channel 304 of the rail 302, and the second orientation tab 1110-2 and the third orientation tab 1110-3 may extend past the sides of the rail 302. In this first orientation, the orientation of the retention bracket 1100 may be connected to and positioned with respect to the rail 302 to cause the ground wire(s) 308 to run perpendicular to the rail 302. Further in a second orientation, the second orientation tab 1110-2 and the third orientation tab 1110-3 may, instead, extend into the channel 304 of the rail 302, and the first orientation tab 1110-1 may extend past the sides of the rail 302. In this second orientation, the orientation of the retention bracket 1100 may be connected to and positioned with respect to the rail 302 to cause the ground wire(s) 308 to run parallel with the rail 302.

The retention bracket 1100 may further include the first terminus 1112-1, the second terminus 1112-2, the third terminus 1112-3, and the fourth terminus 1112-4. The first terminus 1112-1 may extend from a side edge of the second orientation tab 1110-2. Similarly, the second terminus 1112-2 and the third terminus 1112-3 may extend from two opposite side edges of the first orientation tab 1110-1. Further, the fourth terminus 1112-4 may extend from a side edge of the third orientation tab 1110-3. As mentioned above, apart from managing the placement of the ground wire(s) 308 along a length of a solar panel array and ensuring the ground wire(s) 308 is secured to the solar panel array, the grounding lug system 1200 (and other grounding lug systems described herein) may further serve as an electrical conduit for the ground wire(s) 308. The first terminus 1112-1, the second terminus 1112-2, the third terminus 1112-3, and the fourth terminus 1112-4 may be shaped, dimensioned, and bent to contact a portion of the rail 302. For example, the first terminus 1112-1, the second terminus 1112-2, the third terminus 1112-3, and the fourth terminus 1112-4 may contact a top, exterior portion of the first return flange 704-1 and the second return flange 704-2 that extend from a first leg 702-1 and a second leg 702-2 of the rail 302. As similarly depicted in FIG. 8, the first terminus 1112-1, the second terminus 1112-2, the third terminus 1112-3, and the fourth terminus 1112-4 may create markings on the rail similar to markings 802 created by the first contact tab 618-1 and the second contact tab 618-2 contacting the first return flange 704-1 and the second return flange 704-2 when the grounding lug system 1000 of FIG. 9 is connected with the rail 302. As depicted in FIG. 8, the markings 802 on the rail 304 indicate a position where two separate grounding lug systems 1200 have been connected to the rail 302. The markings 802 indicate that the first terminus 1112-1, the second terminus 1112-2, the third terminus 1112-3, and the fourth terminus 1112-4, when securely connected to the first return flange 704-1 and the second return flange 704-2 of the rail 302, may deform or cut into the material of the rail 302. Further, the first terminus 1112-1, the second terminus 1112-2, the third terminus 1112-3, and the fourth terminus 1112-4 may, in this manner, cut through any oxidation, paint, or other layers that may coat the rail 302. This ensures that the electrical conduit for the ground wire(s) 308 may successfully travel from the grounding lug system 1000, to the rail 302, and onto ground 310.

The retention bracket 1100 may be made of a metal, and may be formed from, for example, sheet metal. In one example, the retention bracket 1100 may be made by stamping the sheet metal to reflect the outer shape of the main body 1102, the aperture 1108, the first orientation tab 1110-1, the second orientation tab 1110-2, and the third orientation tab 1110-3, the first terminus 1112-1, the second terminus 1112-2, the third terminus 1112-3, and the fourth terminus 1112-4. Portions of the retention bracket 1100 may then be shaped through bending including bending the main body 1102. Further, the retention bracket 1100 may be shaped by bending the first orientation tab 1110-1, the second orientation tab 1110-2, and the third orientation tab 1110-3 downwards, shaping the depression 1104 and the flange 1106, and by bending the first terminus 1112-1, the second terminus 1112-2, the third terminus 1112-3, and the fourth terminus 1112-4. In one example, the retention bracket 1100 may further be subjected to annealing, tempering, or other heat treatments to obtain a retention bracket 1100 that is able to resist deformation from the state depicted in FIGS. 11 and 12.

With reference to FIGS. 11 and 12, the t-bolt 200 of the grounding lug system 1200 may be utilized to secure the retention bracket 1100 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the aperture 1108 in order to secure the retention bracket 1100 to the rail 302.

The head 202 may be used to clamp the retention bracket 1100 to the rail 302 between the head 202 and the nut 306 and may include the ridges 208 formed on an underside of the head 202 closest to the shaft 204 to assist in creating an electrical grounding path between the retention bracket 1100 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

With the description of the retention bracket 1100 and the t-bolt 200 above, FIG. 12 illustrates a side view of the grounding lug system 1200 including the retention bracket 1100 of FIG. 11 and the t-bolt 200 as viewed from a side of the retention bracket 1100. The rail 302 may include a channel 304 that runs along a length of the rail 302 to allow for the retention bracket 1100 to be connected to the rail 302 to create the grounding lug system 1200. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 1100 may be engaged with the shaft 204 via the aperture 1108. In this manner, the main body 1102 of the retention bracket 1100 may be seated on and secured to a top surface of the rail 302.

Further, the first orientation tab 1110-1 may extend down into the channel 304 of the rail 302 to ensure that the retention bracket 1100 cannot rotate with respect to the rail 302. In this manner, the orientation of the retention bracket 1100 may be maintained so that the ground wire(s) 308 may be retained within the retention bracket 1100 without bending the ground wire(s) 308 or causing the ground wire(s) 308 to divert from an intended path along the solar panel arrays or the rail 302. However, as described above, the retention bracket 1100 may be oriented such that the second orientation tab 1110-2 and the third orientation tab 1110-3 may extend down into the channel 304 of the rail 302 to adjust the orientation of the retention bracket 1100 between the first orientation and the second orientation. In the example of FIGS. 11 and 12, the ground wire(s) 308 is connected to the retention bracket 1100 and the retention bracket 1100 is oriented with respect to the rail 302 such that the ground wire(s) 308 is running perpendicular to the rail 302. However, the retention bracket 1100 may be configured to allow for the ground wire(s) 308 to run perpendicularly and/or parallel with the rail 302 based on the first orientation and the second orientation described above.

As depicted in FIG. 12, the second orientation tab 1110-1 is depicted as it extends downward into the channel 304 of the rail 302. Further, the head 202 of the t-bolt 200 is depicted as engaged with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 are depicted as engaging with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 1100 and/or the threads 206 of the shaft 204, and the electrical ground path may flow from the retention bracket 1100 and/or the threads 206 of the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc, are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the depression 1104 of the retention bracket 1100. At this position, the ground wire(s) 308 may be secured in the retention bracket 1100 via the nut 306, and the depression 1104 may be positioned along a length of the main body 1102 to force the ground wire(s) 308 against the threads 206 of the shaft 204 of the t-bolt 200. In one example, the threads 206 may engage with the ground wire(s) 308 during installation and tightening of the nut 306 against the ground wire(s) 308 and the retention bracket 1100. In this manner, the relatively softer metal (e.g., copper) of the ground wire(s) 308 may be deformed (e.g., elastic deformation or plastic deformation) by the threads 206 as the depression 1104 forces the ground wire(s) 308 against the threads 206.

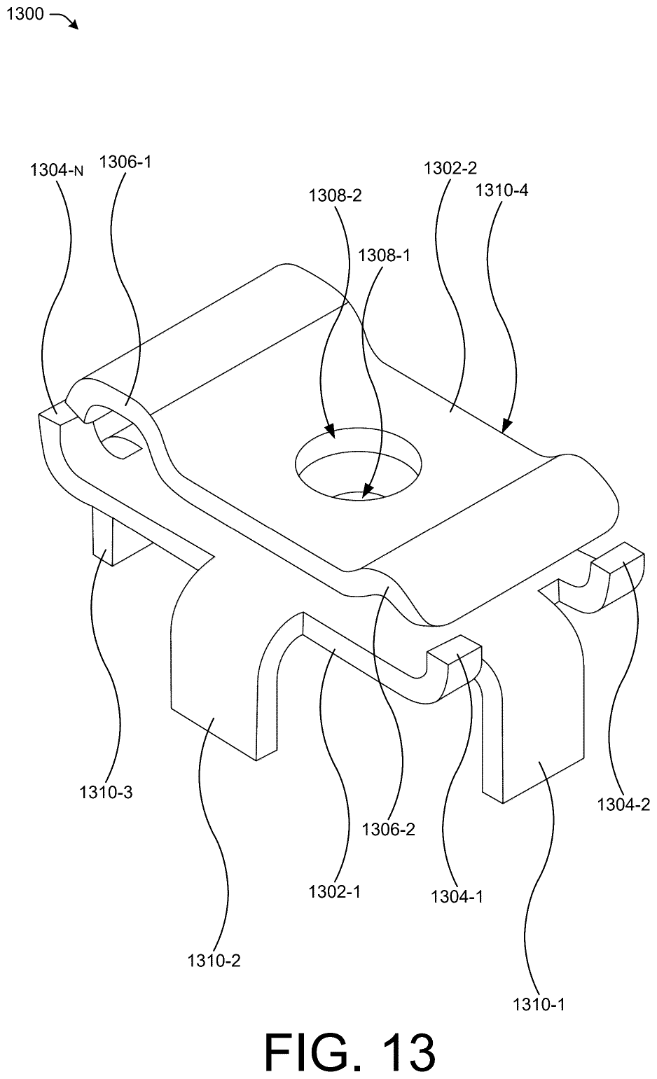

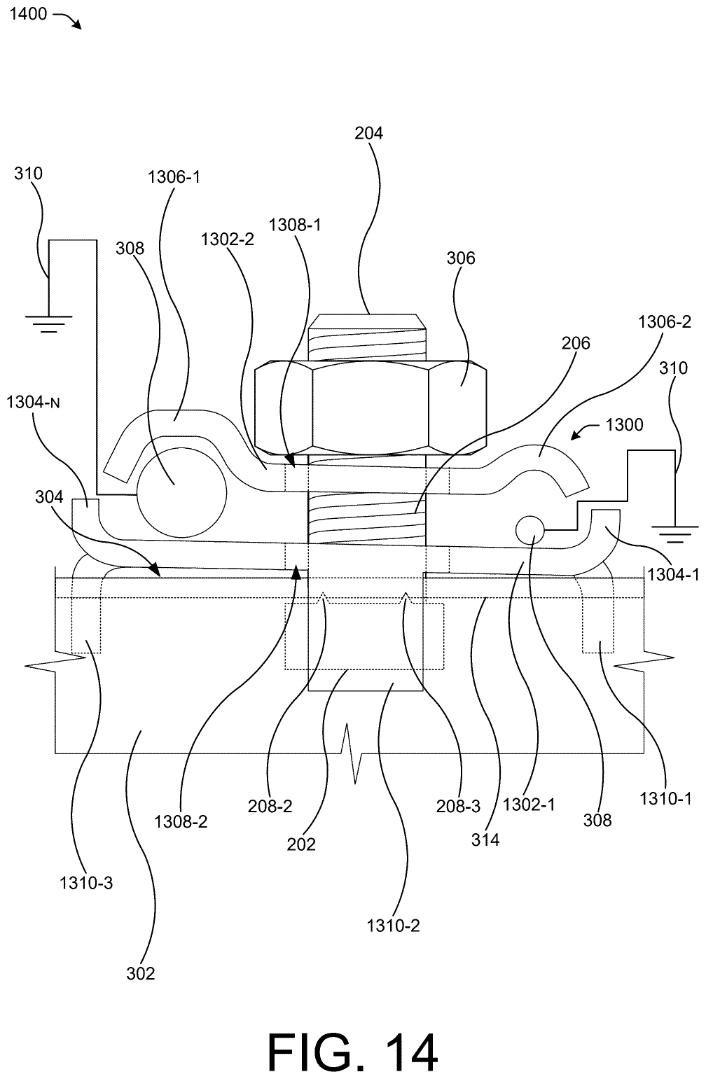

FIG. 13 illustrates a retention bracket 1300 of a grounding lug system 1400, according to an example of the principles described herein. FIG. 14 illustrates the retention bracket 1300 of FIG. 13 incorporated with the grounding lug system 1400 and connected with a rail 302, according to an example of the principles described herein. The retention bracket 1300 may include a first plate 1302-1 and a second plate 1302-2 that mates with the first plate 1302-1. The second plate 1302-2 may include features that nest within the first plate 1302-1.

The first plate 1302-1 may include a plurality of flanges 1304-1, 1304-2,. 1304-N (where N is any integer greater than or equal to 1 (collectively referred to herein as flanges(s) 1304 unless specifically addressed otherwise)) including a first flange 1304-1 and a second flange 1304-2 extending from a first end of the first plate 1302-1 and at least a third flange 1304-N extending from a second end of the first plate 1302-1. Although not depicted, a fourth flange may extend from the second end of the first plate 1302-1 to mirror the first flange 1304-1 and the second flange 1304-2 extending from a first end of the first plate 1302-1.

The first plate 1302-1 may further include a first orientation tab 1310-1, a second orientation tab 1310-2, and a third orientation tab 1310-3. Although not depicted, a fourth orientation tab may extend from a side of the first plate 1302-1 opposite the location of the second orientation tab 1310-2 to mirror the second flange 1304-1 extending from an opposite side of the first plate 1302-1. The first orientation tab 1310-1, the second orientation tab 1310-2, and the third orientation tab 1310-3 (and the fourth orientation tab) may extend from the first plate 1302-1 and turn downwards below the first plate 1302-1. As in other example retention brackets described herein, the first orientation tab 1310-1, the second orientation tab 1310-2, and the third orientation tab 1310-3 (and the fourth orientation tab) may be used to retain the retention bracket 1300 in a desired orientation with respect to the rail 302 to which the retention bracket 1300 may be connected. For example, in a first orientation depicted in FIG. 14, the first orientation tab 1310-1 and third orientation tab 1310-3 may extend into the channel 304 of the rail 302, and the second orientation tab 1310-2 (and the fourth orientation tab) may extend past the sides of the rail 302. In this first orientation, the orientation of the retention bracket 1300 may be connected to and positioned with respect to the rail 302 to cause the ground wire(s) 308 to run perpendicular to the rail 302. Further in a second orientation, the second orientation tab 1310-2 (and the fourth orientation tab) may, instead, extend into the channel 304 of the rail 302, and the first orientation tab 1310-1 and the third orientation tab 1310-3 may extend past the sides of the rail 302. In this second orientation, the orientation of the retention bracket 1300 may be connected to and positioned with respect to the rail 302 to cause the ground wire(s) 308 to run parallel with the rail 302.

The second plate 1302-2 may include a first arched retention arm 1306-1 and a second arched retention arm 1306-2. The first arched retention arm 1306-1 and the second arched retention arm 1306-2 may be formed on opposite sides of the second plate 1302-2. In one example, the first arched retention arm 1306-1 and the second arched retention arm 1306-2 may have different dimensions or sizes to allow for different gauges or sizes of wire 308 to be secured by(or within? or under?) the first arched retention arm 1306-1 and the second arched retention arm 1306-2 as depicted in, for example, FIG. 14. Further, the first arched retention arm 1306-1 and the second arched retention arm 1306-2 may be dimensioned to nest or fit inside the flanges 1304. When the nut 306 is tightened, the second plate 1302-2 may be forced into an engaged position with the first plate 1302-1 such that the ground wire(s) 308 are retained between the internal portions of the first plate 1302-1 and the first arched retention arm 1306-1 and the second arched retention arm 1306-2, respectively, since the flanges 1304 extend past the first arched retention arm 1306-1 and the second arched retention arm 1306-2.

The first plate 1302-1 and the second plate 1302-2 may include a first aperture 1308-1 defined in the first plate 1302-1 and a second aperture 1308-2 defined in the second plate 1302-2. The first aperture 1308-1 and the second aperture 1308-2 may accommodate for the t-bolt 200 of FIG. 2 to extend through the retention bracket 1300 and connect the retention bracket 1300 to the rail 302. In one example, the first aperture 1308-1 and the second aperture 1308-2 may include a circular shape to accommodate for the shaft 204 of the t-bolt 200 to ensure that the retention bracket 1300 does not move with respect to the rail 302 when the t-bolt 200 is used to connect the retention bracket 1300 to the rail 302 and clamp the ground wire(s) 308 between the nut 306 and the retention bracket 1300.

The first plate 1302-1 and the second plate 1302-2 of the retention bracket 1300 may be made of a metal, and may be formed from, for example, sheet metal. In one example, the first plate 1302-1 and the second plate 1302-2 may be made by stamping the sheet metal to reflect the outer shapes of the first plate 1302-1, the second plate 1302-2, the flanges 1304, the first aperture 1308-1, the second aperture 1308-2, the first orientation tab 1310-1, the second orientation tab 1310-2, and the third orientation tab 1310-3 (and the fourth orientation tab). Portions of the retention bracket 1300 may then be shaped through bending including bending the first orientation tab 1310-1, the second orientation tab 1310-2, the third orientation tab 1310-3 (and the fourth orientation tab) downwards and shaping the flanges 1304 upwards. In one example, the retention bracket 1300 may further be subjected to annealing, tempering, or other heat treatments to obtain a retention bracket 1300 that is able to resist deformation from the state depicted in FIGS. 13 and 14. Further, the first arched retention arm 1306-1 and the second arched retention arm 1306-2 may be bent to form their shapes.

With reference to FIGS. 13 and 14, the t-bolt 200 of the grounding lug system 1400 may be utilized to secure the retention bracket 1300 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the first aperture 1308-1 and the second aperture 1308-2 in order to secure the retention bracket 1300 to the rail 302.

The head 202 may be used to clamp the retention bracket 1300 to the rail 302 between the head 202 and the nut 306 and may include the ridges 208 formed on an underside of the head 202 closest to the shaft 204 to assist in creating an electrical grounding path between the retention bracket 1300 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

With the description of the retention bracket 1300 and the t-bolt 200 above, FIG. 14 illustrates a side view of the grounding lug system 1200 including the retention bracket 1300 of FIG. 13 and the t-bolt 200 as viewed from a side of the retention bracket 1300. The rail 302 may include a channel 304 that runs along a length of the rail 302 to allow for the retention bracket 1300 to be connected to the rail 302 to create the grounding lug system 1400. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 1300 may be engaged with the shaft 204 via the first aperture 1308-1 and the second aperture 1308-2. In this manner, the first plate 1302-1 and the second plate 1302-2 of the retention bracket 1300 may be seated on and secured to a top surface of the rail 302.

Further, the first orientation tab 1310-1 and the third orientation tab 1310-3 may extend down into the channel 304 of the rail 302 to ensure that the retention bracket 1300 cannot rotate with respect to the rail 302. In this manner, the orientation of the retention bracket 1300 may be maintained so that the ground wire(s) 308 may be retained within the retention bracket 1300 without bending the ground wire(s) 308 or causing the ground wire(s) 308 to divert from an intended path along the solar panel arrays or the rail 302. However, as described above, the retention bracket 1300 may be oriented such that the second orientation tab 1310-2 (and the fourth orientation tab) may extend down into the channel 304 of the rail 302 to adjust the orientation of the retention bracket 1300 between the first orientation and the second orientation. In the example of FIGS. 13 and 14, the ground wire(s) 308 are connected to the retention bracket 1300 and the retention bracket 1300 is oriented with respect to the rail 302 such that the ground wire(s) 308 is running perpendicular to the rail 302. However, the retention bracket 1300 may be configured to allow for the ground wire(s) 308 to run perpendicularly and/or parallel with the rail 302 based on the first orientation and the second orientation described above.

As depicted in FIG. 14, the first orientation tab 1310-1 and the third orientation tab 1310-3 are depicted as they extend downward into the channel 304 of the rail 302. Further, the head 202 of the t-bolt 200 is depicted as engaged with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 are depicted as engaging with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 1300 and/or the threads 206 of the shaft 204, and the electrical ground path may flow from the retention bracket 1300 and/or the threads 206 of the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc, are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the first arched retention arm 1306-1 and/or the second arched retention arm 1306-2 of the retention bracket 1300. At this position, the ground wire(s) 308 may be secured in the retention bracket 1300 via the nut 306 between the first plate 1302-1 and second plate 1302-2. The ground wire(s) 308 may form the grounding path through the first plate 1302-1 and second plate 1302-2, the nut 306, the shaft 204 and head 202 of the t-bolt 200, into the rail 302, and onto ground 310.

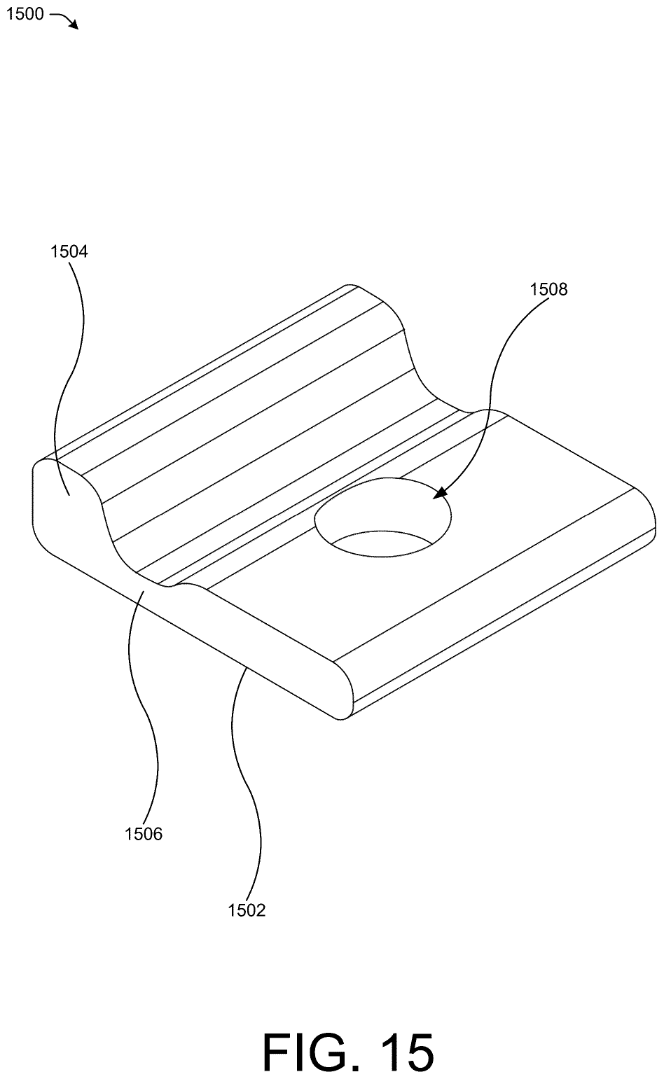

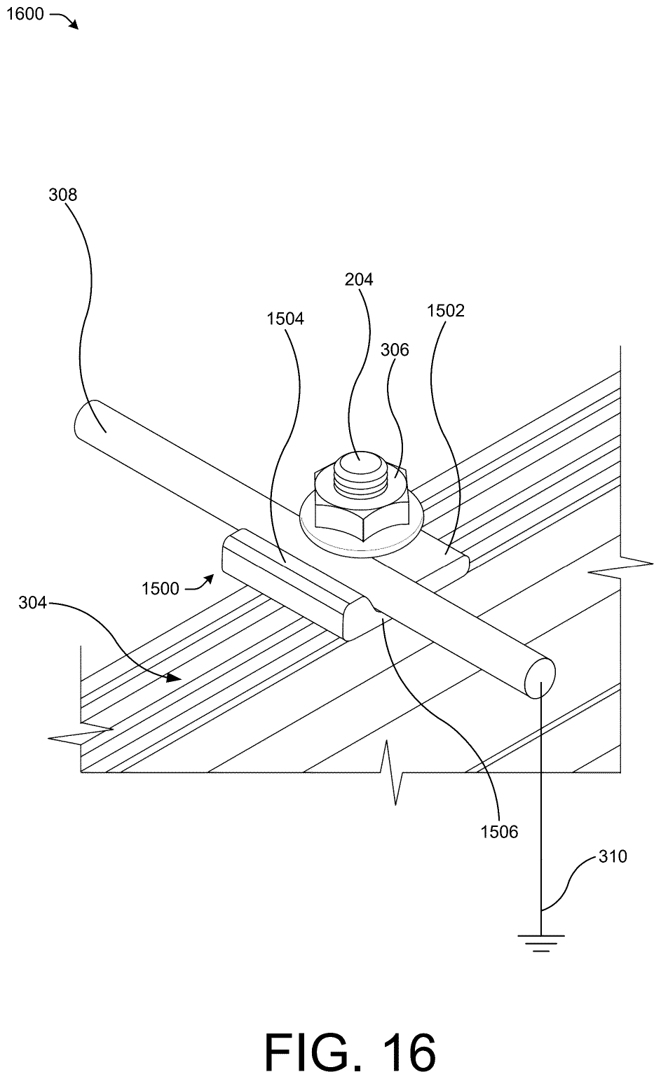

FIG. 15 illustrates a retention bracket 1500 of a grounding lug system 1600, according to an example of the principles described herein. FIG. 16 illustrates the retention bracket 1500 of FIG. 15 incorporated with the grounding lug system 1600 and connected with the rail 302, according to an example of the principles described herein. The retention bracket 1500 may include a main body 1502. The main body 1502 may include a depression 1506 that extends below the main body 1502 and a buttress 1504 that extends from the depression 1506 and above the main body 1502. The depression 1506 may function as a position along a length of the main body 1502 of the retention bracket 1500 at which the ground wire(s) 308 may be seated and may be dimensioned to accommodate ground wires of various gauges. In this manner, the depression 1506 and the buttress 1504 serve to retain any wires (e.g., the ground wire(s) 308) that are introduced into the space between the retention bracket 1500 and the nut 306. In other words, the nut 306 serves as the element that secures the ground wire(s) 308 to the retention bracket 1500.

The main body 1502 may include an aperture 1508 defined therein. The aperture 1508 may accommodate for the t-bolt 200 of FIG. 2 to extend through the retention bracket 1500 and connect the retention bracket 1500 to the rail 302. In one example, the aperture 1508 may include a circular shape to accommodate for the shaft 204 of the t-bolt 200 to ensure that the retention bracket 1500 does not move with respect to the rail 302 when the t-bolt 200 is used to connect the retention bracket 1500 to the rail 302 and clamp the ground wire(s) 308 between the nut 306 and the retention bracket 1500.

The retention bracket 1500 may include orientation tabs as described herein, but in the example of FIGS. 15 and 16, the retention bracket 1500 does not include orientation tabs. This allows the retention bracket 1500 to be connected to the rail 302 at any orientation and secure the ground wire(s) 308 at any angle that may be beneficial to the location of the ground wire(s) 308.

The retention bracket 1500 may be made of a metal. In one example, the retention bracket 1500 may be made by machining, milling, casting, forging, extrusion, forming, or other metal object manufacturing processes to reflect the outer shape of the main body 1502, the depression 1506, the buttress 1504, and the aperture 1508. Portions of the retention bracket 1500 may also be shaped through bending to obtain the shape as depicted in FIGS. 15 and 16. In one example, the retention bracket 1500 may further be subjected to annealing, tempering, or other heat treatments to obtain a retention bracket 1500 that is able to resist deformation from the state depicted in FIGS. 15 and 16.

With reference to FIGS. 15 and 16, the t-bolt 200 of the grounding lug system 1000 may be utilized to secure the retention bracket 1500 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the aperture 1508 in order to secure the retention bracket 1500 to the rail 302.

The head 202 may be used to clamp the retention bracket 1500 to the rail 302 between the head 202 and the nut 306 and may include the ridges 208 formed on an underside of the head 202 closest to the shaft 204 to assist in creating an electrical grounding path between the retention bracket 1500 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

With the description of the retention bracket 1500 and the t-bolt 200 above, FIG. 16 illustrates a perspective view of the grounding lug system 1600 including the retention bracket 1500 of FIG. 15 and the t-bolt 200. The rail 302 may include the channel 304 that runs along a length of the rail 302 to allow for the retention bracket 1500 to be connected to the rail 302 to create the grounding lug system 1600. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 1500 may be engaged with the shaft 204 via the aperture 1508. In this manner, the main body 1502 of the retention bracket 1500 may be seated on and secured to a top surface of the rail 302.

As described above, the head 202 of the t-bolt 200 engages with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 engage with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 1500 and/or the threads 206 of the shaft 204, and the electrical ground path may flow from the retention bracket 1500 and/or the nut and/or the threads 206 of the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc, are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the depression 1506 of the retention bracket 1500. At this position, the ground wire(s) 308 may be secured in the retention bracket 1500 via the nut 306, and the depression 1506 may be positioned along a length of the main body 1502 to force the ground wire(s) 308 against the threads 206 of the shaft 204 of the t-bolt 200. In one example, the threads 206 may engage with the ground wire(s) 308 during installation and tightening of the nut 306 against the ground wire(s) 308 and the retention bracket 1500. In this manner, the relatively softer metal (e.g., copper) of the ground wire(s) 308 may be deformed (e.g., elastic deformation or plastic deformation) by the threads 206 as the depression 1506 forces the ground wire(s) 308 against the threads 206.

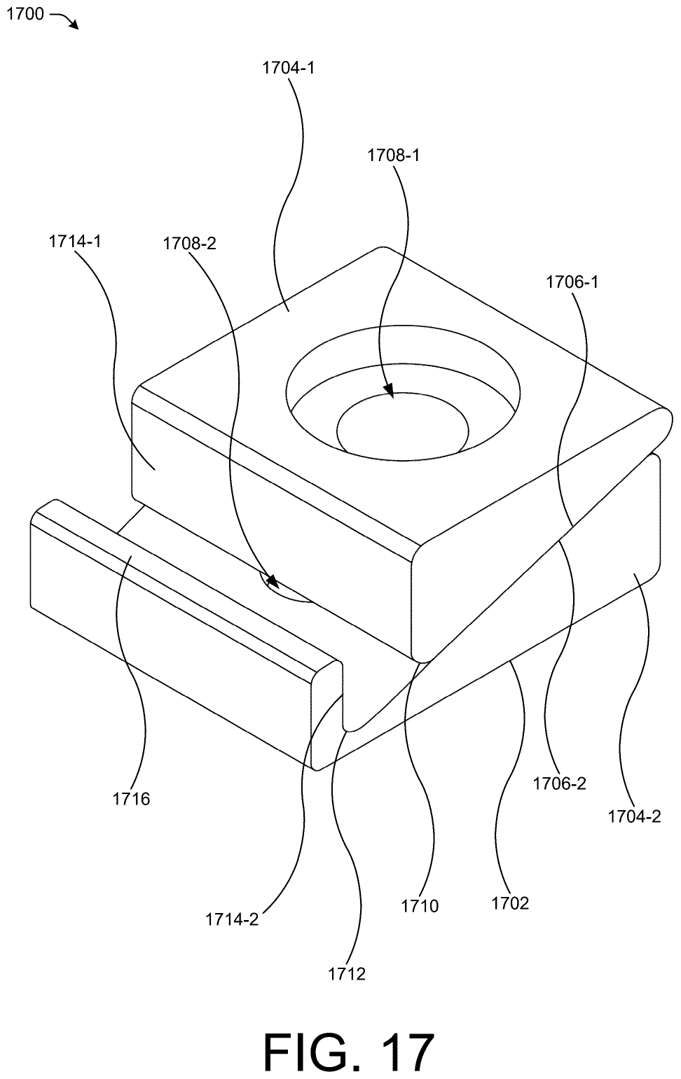

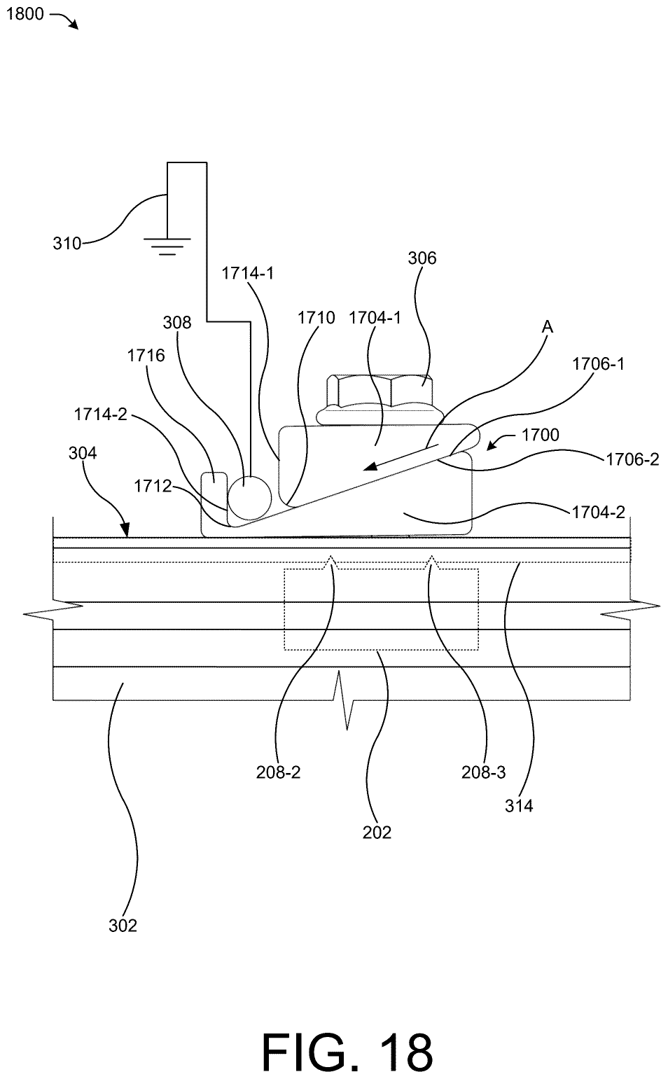

FIG. 17 illustrates a retention bracket 1700 of a grounding lug system 1800, according to an example of the principles described herein. FIG. 18 illustrates the retention bracket 1700 of FIG. 17 incorporated with the grounding lug system 1800 and connected with a rail 302, according to an example of the principles described herein. The retention bracket 1700 may include a main body 1702. The main body 1502 may include a first wedge plate 1704-1 and a second wedge plate 1704-2. The first wedge plate 1704-1 may include a first incline plane 1706-1 and the second wedge plate 1704-2 may include a second incline plane 1706-2. The first incline plane 1706-1 and the second incline plane 1706-2 may slidingly mate with one another.

The first wedge plate 1704-1 may include a first aperture 1708-1 defined therein and the second wedge plate 1704-2 may include a second aperture 1708-2 defined therein. The shaft 204 of the t-bolt 200 may extend through the first aperture 1708-1 and the second aperture 1708-2 to connect the first wedge plate 1704-1 and the second wedge plate 1704-2 to one another and to connect the main body 1702 of the retention bracket 1700. In one example, the first aperture 1708-1 may include a circular shape and the second aperture 1708-2 may include an elongated or elliptical shape Both the first aperture 1708-1 and the second aperture 1708-2 may accommodate for the shaft 204 of the t-bolt 200 to ensure that the retention bracket 1700 does not move with respect to the rail 302 when the t-bolt 200 is used to connect the retention bracket 1700 to the rail 302 and clamp the ground wire(s) 308 between the nut 306 and the retention bracket 1700. When the t-bolt 200 is used to connect the retention bracket 1700 to the rail 302, the elliptical shape of the second aperture 1708-2 allows for the first wedge plate 1704-1 to move slide along the second wedge plate 1704-2.

The first wedge plate 1704-1 includes a first face 1714-1 and an external rounded corner 1710 formed at a bottom of the first face 1714-1. Further, the second wedge plate 1704-2 may include a buttress 1716 including a second face 1714-2 that runs approximately parallel to the first face 1714-1 of the first wedge plate 1704-1. Further, the second wedge plate 1704-2 may include an internal rounded corner 1712 formed at the bottom of the second face 1714-2 and between the second incline plane 1706-2 and the second face 1714-2. The first face 1714-1 may be angled relative to the second face 1714-2 such that the planes of the first face 1714-1 and the second face 1714-2 intersect above the wire 308 and form an acute angle at their intersection which, in turn, traps the wire 308 between surfaces of the first face 1714-1, the second face 1714-2, and the second incline plane 1706-2.

As depicted in FIG. 18, the ground wire(s) 308 may be secured between the first face 1714-1 of the first wedge plate 1704-1 and the second face 1714-2 of the buttress 1716 of the second wedge plate 1704-2. Specifically, arrow A depicts the manner in which the first wedge plate 1704-1 slidingly engages with the second wedge plate 1704-2 as the nut 306 connected to the t-bolt 200 is tightened. As this occurs, the first incline plane 1706-1 of the first wedge plate 1704-1 slides along the second incline plane 1706-2 of the second wedge plate 1704-2 and causes the first face 1714-1 of the first wedge plate 1704-1 to draw closer to the second face 1714-2 of the buttress 1716 of the second wedge plate 1704-2. In this manner, the ground wire(s) 308 may be secured between the first face 1714-1 and the second face 1714-2. The internal rounded corner 1712 formed at the bottom of the second face 1714-2 and between the second incline plane 1706-2 and the second face 1714-2 may be shaped and dimensioned to accommodate ground wire(s) 308 of various gauges. The external rounded corner 1710 may cause the ground wire(s) 308 to be seated entirely within the internal rounded corner 1712. Further, in one example, the pressure placed on the ground wire(s) 308 through the clamping force between the first face 1714-1 and the second face 1714-2 may cause the relatively softer metal (e.g., copper) of the ground wire(s) 308 to be deformed (e.g., elastic deformation or plastic deformation) and this force may cause the external rounded corner 1710 to force the ground wire(s) 308 to form into the shape of the internal rounded corner 1712. In this manner, the internal rounded corner 1712 and the external rounded corner 1710 serve to retain any wires (e.g., the ground wire(s) 308) that are introduced into the space between the first incline plane 1706-1 and second incline plane 1706-2.

The retention bracket 1700 may include orientation tabs as described herein, but in the example of FIGS. 17 and 18, the retention bracket 1700 does not include orientation tabs. This allows the retention bracket 1700 to be connected to the rail 302 at any orientation and secure the ground wire(s) 308 at any angle that may be beneficial to the location of the ground wire(s) 308.

The retention bracket 1700 may be made of a metal. In one example, the retention bracket 1700 may be made by machining, milling, casting, forging, extrusion, forming, or other metal object manufacturing processes to reflect the outer shape of the main body 1702, the first wedge plate 1704-1, the second wedge plate 1704-2, and their respective elements. Portions of the retention bracket 1700 may also be shaped through bending to obtain the shape as depicted in FIGS. 17 and 18. In one example, the retention bracket 1700 may further be subjected to annealing, tempering, or other heat treatments to obtain a retention bracket 1700 that is able to resist deformation from the state depicted in FIGS. 17 and 18.

With reference to FIGS. 17 and 18, the t-bolt 200 of the grounding lug system 1800 may be utilized to secure the retention bracket 1700 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the aperture 1508 in order to secure the retention bracket 1700 to the rail 302.

The head 202 may be used to clamp the retention bracket 1700 to the rail 302 between the head 202 and the nut 306 and may include the ridges 208 formed on an underside of the head 202 closest to the shaft 204 to assist in creating an electrical grounding path between the retention bracket 1700 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

With the description of the retention bracket 1700 and the t-bolt 200 above, FIG. 18 illustrates a perspective view of the grounding lug system 1800 including the retention bracket 1700 of FIG. 17 and the t-bolt 200. The rail 302 may include the channel 304 that runs along a length of the rail 302 to allow for the retention bracket 1700 to be connected to the rail 302 to create the grounding lug system 1800. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 1700 may be engaged with the shaft 204 via the first aperture 1708-1 and the second aperture 1708-2. In this manner, the main body 1702 of the retention bracket 1700 may be seated on and secured to a top surface of the rail 302.

As described above, the head 202 of the t-bolt 200 engages with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 engage with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 1700, and the electrical ground path may flow from the retention bracket 1700, to the nut 306, to the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc., are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

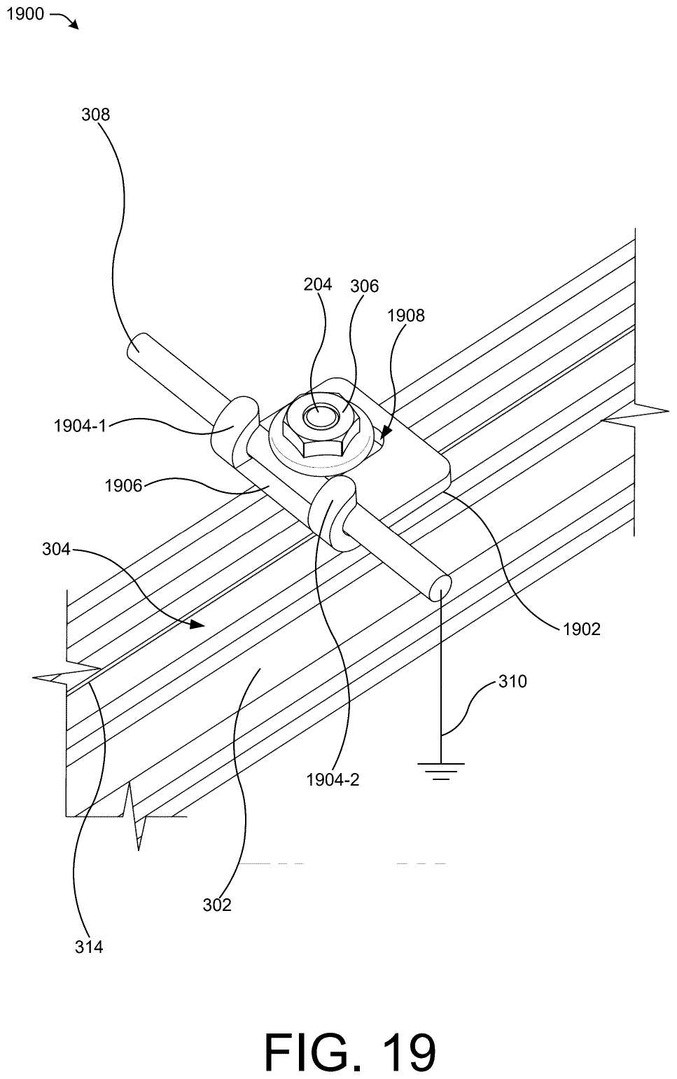

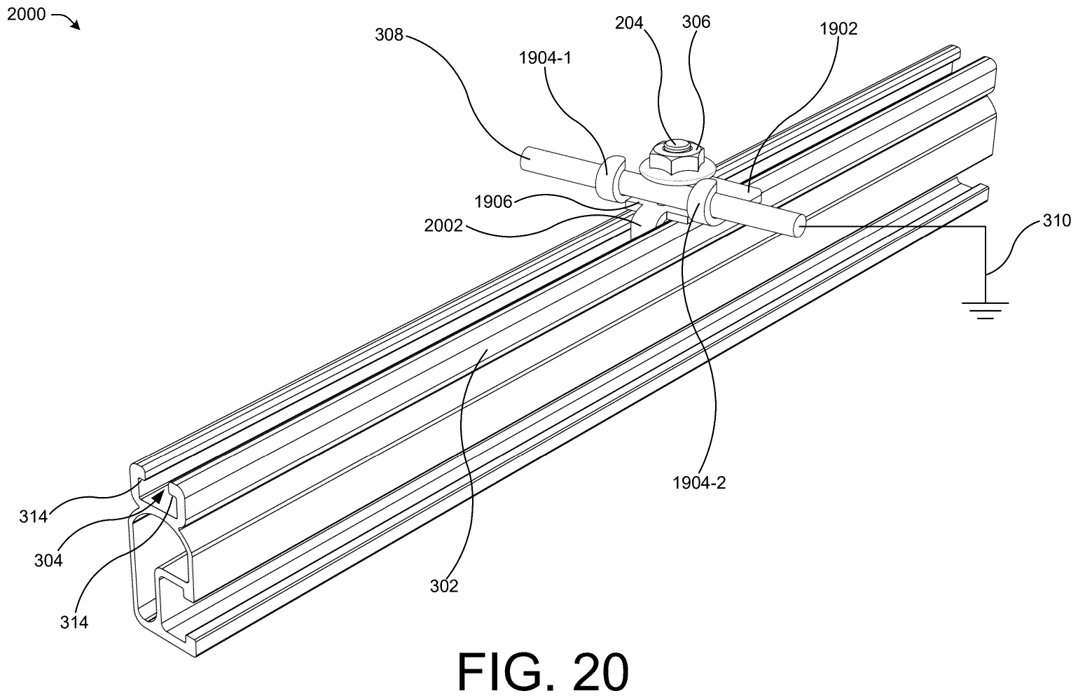

FIG. 19 illustrates a top perspective view of a retention bracket 1900 incorporated with a grounding lug system 2000 and connected with a rail 302, according to an example of the principles described herein. FIG. 20 illustrates a top perspective view of the retention bracket 1900 incorporated with a grounding lug system 2000 of FIG. 19, according to an example of the principles described herein. The retention bracket 1900 may include a main body 1902. The main body 1902 may include a first hook 1904-1 and a second hook 1904-2 extending from a rounded end 1906 of the main body 1902. The first hook 1904-1 and the second hook 1904-2 may function as retention devices in which the ground wire(s) 308 may be seated. The first hook 1904-1 and the second hook 1904-2 may be dimensioned to accommodate ground wires of various gauges. In this manner, the first hook 1904-1 and the second hook 1904-2 serve to retain any wires (e.g., the ground wire(s) 308) that are introduced into the space between the retention bracket 1900 and the nut 306. In other words, the nut 306 serves as the element that secures the ground wire(s) 308 to the retention bracket 1900.

The main body 1902 may include an aperture 1908 defined therein. The aperture 1908 may accommodate for the t-bolt 200 of FIG. 2 to extend through the retention bracket 1900 and connect the retention bracket 1900 to the rail 302. In one example, the aperture 1908 may have an oval shape to allow for the shaft 204 of the t-bolt 200 to be moved within the aperture 1908 to connect the retention bracket 400 to the rail 302 and clamp the ground wire(s) 308 securely between the shaft 204 and the first hook 1904-1 and the second hook 1904-2.

The retention bracket 1900 may include orientation tabs as described herein, but in the example of FIG. 19 the retention bracket 1900 does not include orientation tabs. However, in the example of FIG. 20, an orientation tab 2002 is depicted as being formed between the first hook 1904-1 and the second hook 1904-2. Examples where the retention bracket 1900 does not include the orientation tab 2002 as in FIG. 19, this allows the retention bracket 1900 to be connected to the rail 302 at any orientation and secure the ground wire(s) 308 at any angle that may be beneficial to the location of the ground wire(s) 308. In examples where the retention bracket 1900 includes the orientation tab 2002, the orientation tab 2002 may be used to retain the retention bracket 1900 in a desired orientation with respect to the rail 302. For example, the orientation tab 2002 may extend into the channel 304 of the rail 302 as depicted in FIG. 20 and other figures that depict a rail 302 with retention brackets that include an orientation tab.

The retention bracket 1900 may be made of a metal. In one example, the retention bracket 1900 may be made by machining, milling, casting, forging, extrusion, forming, or other metal object manufacturing processes to reflect the outer shape of the main body 1902, the first hook 1904-1, the second hook 1904-2, the aperture 1908, and the orientation tab 2002. Portions of the retention bracket 1900 may also be shaped through bending to obtain the shape as depicted in FIGS. 19 and 20. In one example, the retention bracket 1900 may further be subjected to annealing, tempering, or other heat treatments to obtain a retention bracket 1900 that is able to resist deformation from the state depicted in FIGS. 19 and 20.

With reference to FIGS. 19 and 20, the t-bolt 200 of the grounding lug system 2000 may be utilized to secure the retention bracket 1900 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the aperture 1908 in order to secure the retention bracket 1900 to the rail 302.

The head 202 may be used to clamp the retention bracket 1900 to the rail 302 between the head 202 and the nut 306 and may include the ridges 208 formed on an underside of the head 202 closest to the shaft 204 to assist in creating an electrical grounding path between the retention bracket 1900 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

With the description of the retention bracket 1900 and the t-bolt 200 above, FIG. 20 illustrates a perspective view of the grounding lug system 2000 including the retention bracket 1900 of FIG. 19 and the t-bolt 200. The rail 302 may include the channel 304 that runs along a length of the rail 302 to allow for the retention bracket 1900 to be connected to the rail 302 to create the grounding lug system 2000. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 1900 may be engaged with the shaft 204 via the aperture 1908. In this manner, the main body 1902 of the retention bracket 1900 may be seated on and secured to a top surface of the rail 302.

As described above, the head 202 of the t-bolt 200 engages with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 engage with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 1900 and the nut 306 the threads 206 of the shaft 204, and the electrical ground path may flow from the retention bracket 1900 and/or the threads 206 of the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc., are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the first hook 1904-1 and the second hook 1904-2 of the retention bracket 1900. At this position, the ground wire(s) 308 may be secured in the retention bracket 1900 via the nut 306, and the first hook 1904-1 and the second hook 1904-2 may be positioned along a length of the main body 1902 to force the ground wire(s) 308 against the threads 206 of the shaft 204 of the t-bolt 200. In one example, the threads 206 may engage with the ground wire(s) 308 during installation and tightening of the nut 306 against the ground wire(s) 308 and the retention bracket 1900. In this manner, the relatively softer metal (e.g., copper) of the ground wire(s) 308 may be deformed (e.g., elastic deformation or plastic deformation) by the threads 206 as the first hook 1904-1 and the second hook 1904-2 force the ground wire(s) 308 against the threads 206. This increases the electrical coupling of the ground wire(s) 308 to the t-bolt 200.

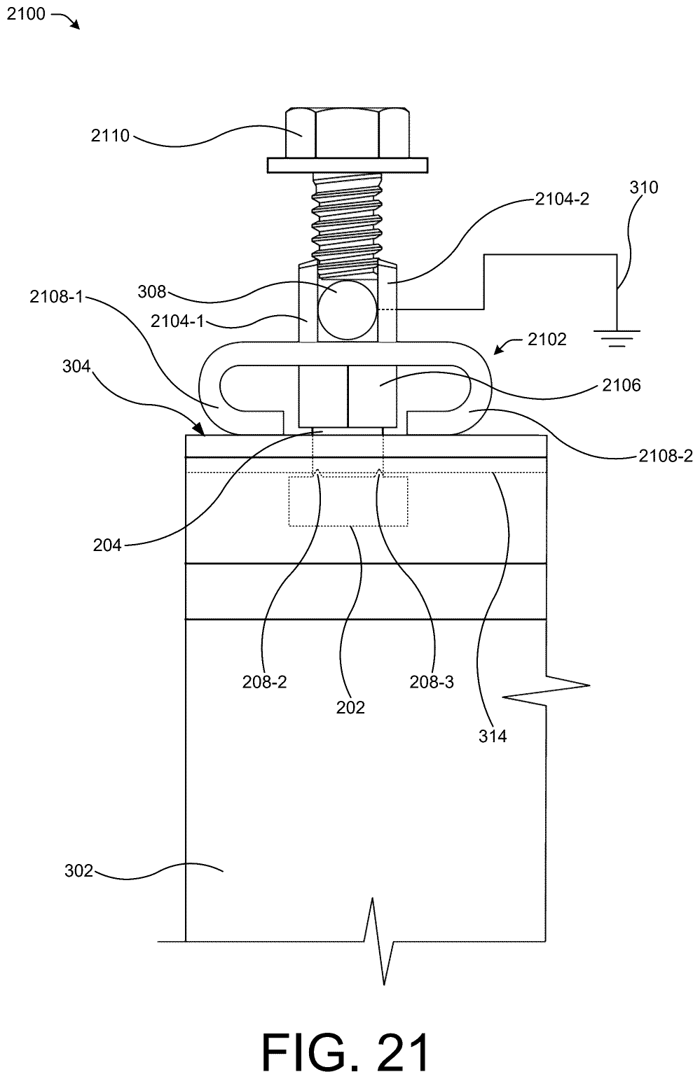

FIG. 21 illustrates a side view of a retention bracket 2102 incorporated with a grounding lug system 2100 and connected with a rail 302, according to an example of the principles described herein. The grounding lug system 2100 of FIG. 21 may include a first semicircular wing 2108-1 and a second semicircular wing 2108-2 connected to a base 2106 and extending in opposite directions from the base 2106. The first semicircular wing 2108-1 and the second semicircular wing 2108-2 may extend outwards away from the base 2106, turn downwards towards the rail 302, and turn again back towards the base 2106 parallel with the first extension of the first semicircular wing 2108-1 and the second semicircular wing 2108-2 from the base 2106 such that the first semicircular wing 2108-1 and the second semicircular wing 2108-2 each form semicircular cross-sectional shapes. In one example, the terminal ends of the first semicircular wing 2108-1 and the second semicircular wing 2108-2 that do not connect to the base 2106 may directly contact a top surface of the rail 302. Further, in one example, the terminal ends of the first semicircular wing 2108-1 and the second semicircular wing 2108-2 may be forced against the top of the rail 302 as the nut 306 is tightened onto the shaft 204 of the t-bolt 200.

The retention bracket 2102 may further include a slotted, internally threaded shaft including a first stanchion 2104-1 and a second stanchion 2104-2. The first stanchion 2104-1 and the second stanchion 2104-2 may extend from the base 2106 in a direction parallel with the shaft 204 of the t-bolt 200. In one example the first stanchion 2104-1 and the second stanchion 2104-2 may extend from the base 2106 in a direction perpendicular to the shaft 204 of the t-bolt 200 or in any direction.

The internal threads of the first stanchion 2104-1 and the second stanchion 2104-2 may be configured to engage with a set screw 2110. The set screw 2120 may be used to secure the ground wire(s) 308 by pressure and/or friction within or against the first stanchion 2104-1 and the second stanchion 2104-2. The set screw 2110 may include the bolt depicted in FIG. 21 or may include, for example, a grub screw, a blind screw, or other headless screw. The set screw 2110 may be screwed into the threaded recess between the threads of the first stanchion 2104-1 and the second stanchion 2104-2. The set screw 2110 may be forced into the relatively softer metal (e.g., copper) of the ground wire(s) 308 such that the ground wire(s) 308 becomes deformed (e.g., elastic deformation or plastic deformation) by the end of the set screw 2110 forces the ground wire(s) 308 against the threads 206.

The retention bracket 2102 may include orientation tabs as described herein, but in the example of FIG. 21, the retention bracket 2102 does not include orientation tabs. This allows the retention bracket 2102 to be connected to the rail 302 at any orientation and secure the ground wire(s) 308 at any angle that may be beneficial to the location of the ground wire(s) 308.

The retention bracket 2102 may be made of a metal. In one example, the retention bracket 2102 may be made by machining, milling, casting, forging, extrusion, forming, or other metal object manufacturing processes to reflect the outer shape of the first semicircular wing 2108-1, the second semicircular wing 2108-2, the base 2106, the first stanchion 2104-1, the second stanchion 2104-2, or other elements of the retention bracket 2102. Portions of the retention bracket 2102 may also be shaped through bending to obtain the shape as depicted in FIG. 21. In one example, the retention bracket 2102 may further be subjected to annealing, tempering, or other heat treatments to obtain a retention bracket 2102 that is able to resist deformation from the state depicted in FIG. 21.

With reference to FIG. 21, the t-bolt 200 of the grounding lug system 2100 may be utilized to secure the retention bracket 2102 to the rail 302. The t-bolt 200 as mentioned above may include a head 202 perpendicularly connected to the shaft 204. The shaft 204 may include the threads 206 formed thereon to allow the shaft 204 to engage with a mating nut 306 through an aperture defined in the retention bracket 2102 in order to secure the retention bracket 2102 to the rail 302.

The head 202 may be used to clamp the retention bracket 2102 to the rail 302 between the head 202 and the nut 306 and may include the ridges 208 formed on an underside of the head 202 closest to the shaft 204 to assist in creating an electrical grounding path between the retention bracket 2102 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

The rail 302 may include the channel 304 that runs along a length of the rail 302 to allow for the retention bracket 2102 to be connected to the rail 302 to create the grounding lug system 2100. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 2102 may be engaged with the shaft 204 via the aperture defined in the retention bracket 2102. In this manner, the retention bracket 2102 may be seated on and secured to a top surface of the rail 302.

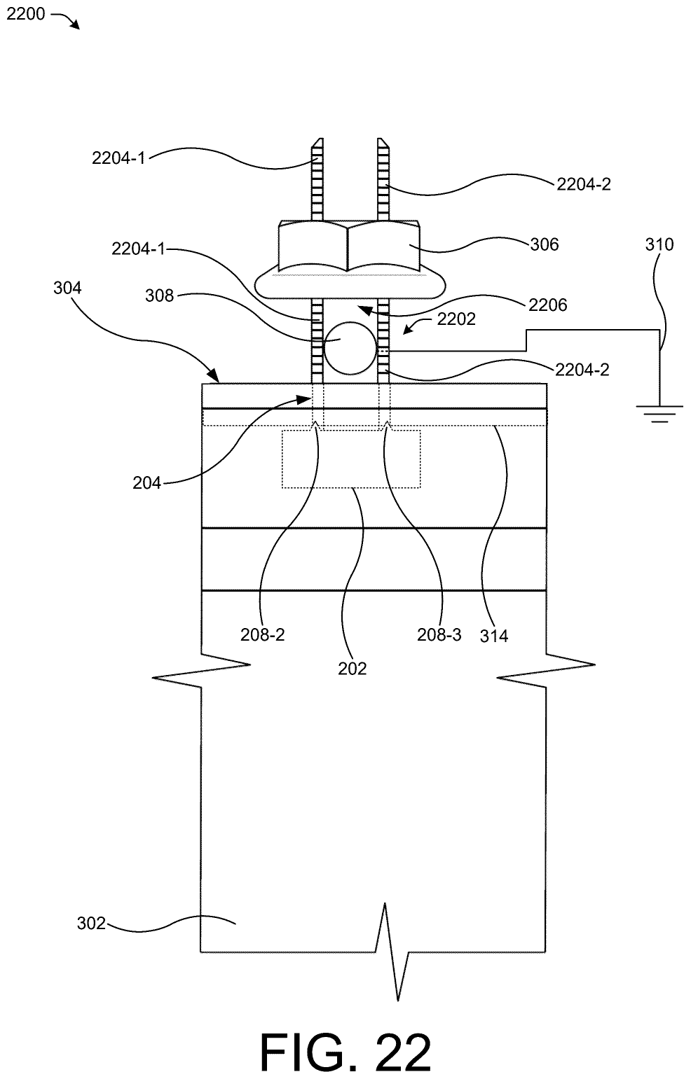

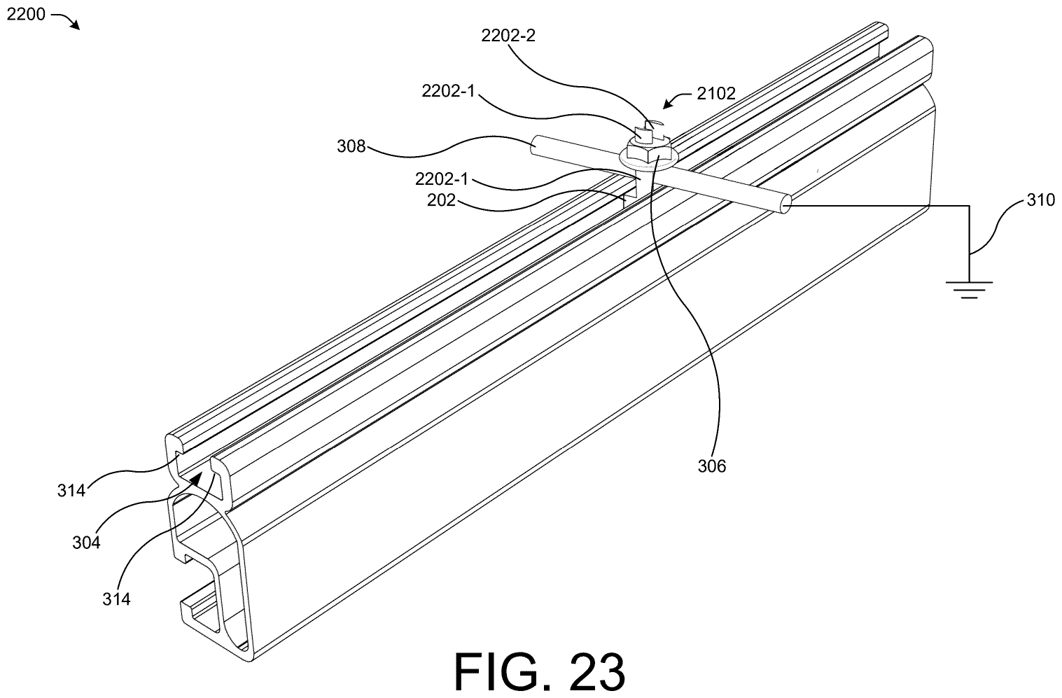

FIG. 22 illustrates a side view of a retention bracket 2202 incorporated with a grounding lug system 2200 and connected with a rail 302, according to an example of the principles described herein. FIG. 23 illustrates a top perspective view of the retention bracket 2202 incorporated with a grounding lug system 2200 of FIG. 22, according to an example of the principles described herein. The retention bracket 2202 of the grounding lug system 2200 of FIGS. 22 and 23 may include a slotted, externally threaded shaft including a first stanchion 2204-1 and a second stanchion 2204-2. The first stanchion 2204-1 and the second stanchion 2204-2 may extend from the head 202 of the t-bolt 200 such that the first stanchion 2204-1 and the second stanchion 2204-2 are formed in the shaft 204 of the t-bolt 200. In other words, a channel 2206 may be defined in the shaft 204 of the t-bolt 200 to form the first stanchion 2204-1 and the second stanchion 2204-2.

The external threads of the first stanchion 2204-1 and the second stanchion 2204-2 may be configured to engage with the nut 306. The nut 306 may be used to secure the ground wire(s) 308 by pressure and/or friction within or against the first stanchion 2204-1 and the second stanchion 2204-2. The reduced complexity of the example retention bracket 2202 of FIGS. 22 and 23 may decrease the costs associated with the manufacturing of a retention bracket, reduce the complexity of installing the retention bracket into the rail 302, and other beneficial advantages.

The retention bracket 2202 may include orientation tabs as described herein, but in the example of FIGS. 22 and 23, the retention bracket 2202 does not include orientation tabs. This allows for the first stanchion 2204-1 and the second stanchion 2204-2 to be defined in the retention bracket 2202 at any angle with respect to the orientation of the head 202 of the t-bolt 200 and secure the ground wire(s) 308 at any angle that may be beneficial to the location of the ground wire(s) 308.

The retention bracket 2202 may be made of a metal. In one example, the retention bracket 2202 may be made by machining, milling, casting, forging, extrusion, forming, or other metal object manufacturing processes to reflect the outer shape of the first stanchion 2204-1 and the second stanchion 2204-2, the t-bolt 200 or other elements of the retention bracket 2202. Portions of the retention bracket 2202 may also be shaped through bending to obtain the shape as depicted in FIGS. 22 and 23. In one example, the retention bracket 2202 may further be subjected to annealing, tempering, or other heat treatments to obtain a retention bracket 2202 that is able to resist deformation from the state depicted in FIGS. 22 and 23.

With reference to FIGS. 22 and 23, the t-bolt 200 of the grounding lug system 2200 may be utilized to secure the retention bracket 2202 to the rail 302. The t-bolt 200 as mentioned above may include a head 202 perpendicularly connected to the shaft 204 (e.g., the first stanchion 2204-1 and the second stanchion 2204-2). The shaft 204 may include the threads 206 formed thereon to allow the shaft 204 to engage with the mating nut 306 through an aperture defined in the retention bracket 2202 in order to secure the retention bracket 2202 to the rail 302.

The head 202 may be used to clamp the retention bracket 2202 to the rail 302 between the head 202 and the nut 306 and may include the ridges 208 formed on an underside of the head 202 closest to the shaft 204 (e.g., the first stanchion 2204-1 and the second stanchion 2204-2) to assist in creating an electrical grounding path between the retention bracket 2202 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

The rail 302 may include the channel 304 that runs along a length of the rail 302 to allow for the retention bracket 2202 to be connected to the rail 302 to create the grounding lug system 2200. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 2202 may be engaged with the shaft 204 via the aperture defined in the retention bracket 2202. In this manner, the retention bracket 2202 may be seated on and secured to a top surface of the rail 302.

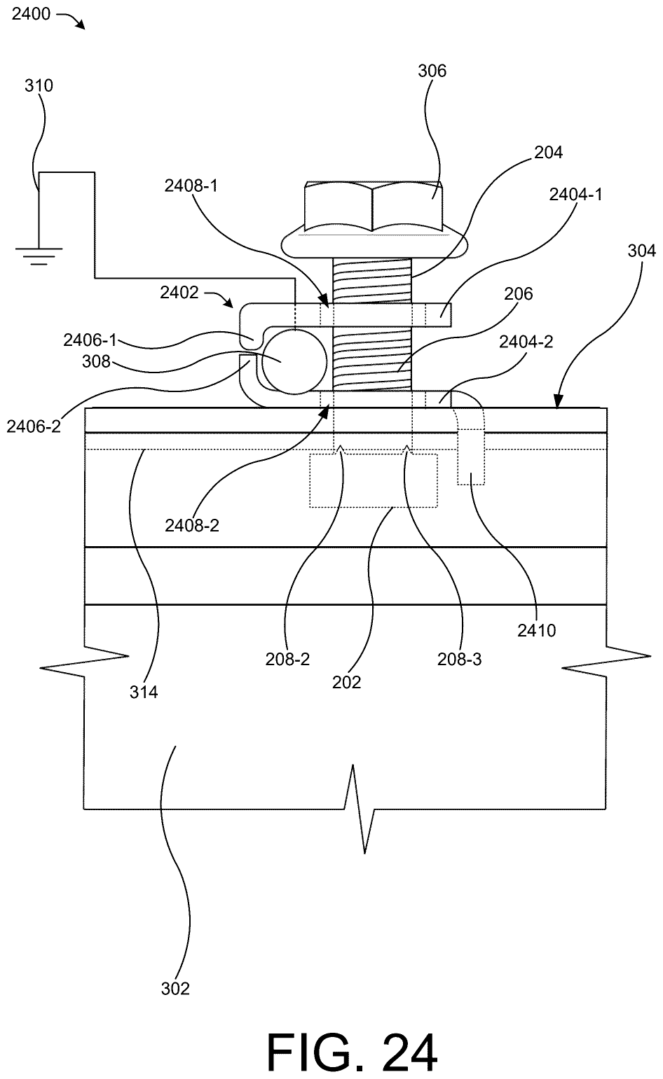

FIG. 24 illustrates a side view of a retention bracket 2402 incorporated with a grounding lug system 2400 and connected with a rail 302, according to an example of the principles described herein. The retention bracket 2402 may include a first plate 2404-1 and a second plate 2404-2 that mates with the first plate 2404-1. The second plate 2404-2 may include features that interface with the first plate 2404-1 to create an enclosed space in which the wire(s) 308 may be seated.

The first plate 2404-1 may include a first arched retention arm 2406-1 extending from an end of the first plate 2404-1. The second plate 2404-2 may include a second arched retention arm 2406-2 extending from an end of the second plate 2404-2. The first arched retention arm 2406-1 and the second arched retention arm 2406-2 may be formed on the same sides of the first plate 2404-1 and the second plate 2404-2, respectively. In one example, the first arched retention arm 2406-1 and the second arched retention arm 2406-2 may have different dimensions or sizes to allow for different gauges or sizes of ground wire(s) 308 to be secured between the first arched retention arm 2406-1 and the second arched retention arm 2406-2 as depicted in, for example, FIG. 24. Further, the first arched retention arm 2406-1 and the second arched retention arm 2406-2 may be dimensioned to interface with one another to enclose the ground wire(s) 308 within a negative space created by the first arched retention arm 2406-1 and the second arched retention arm 2406-2. When the nut 306 is tightened, the first plate 2404-1 may be forced into an engaged position with the second plate 2404-2 such that the ground wire(s) 308 are retained between the internal portions of the first plate 2404-1 and the first arched retention arm 2406-1 and the second arched retention arm 2406-2, respectively.

The second plate 2404-2 may further include an orientation tab 2410. Although not depicted, any number of orientation tabs may be formed and extend from the second plate 2404-2. The orientation tab 2410 may extend from the second plate 2404-2 and turn downwards below the second plate 2404-2. As in other example retention brackets described herein, the orientation tab 2410 may be used to retain the retention bracket 2402 in a desired orientation with respect to the rail 302 to which the retention bracket 2402 may be connected. For example, in a first orientation depicted in FIG. 24, the orientation tab 2410—may extend into the channel 304 of the rail 302. However, in examples where the orientation tab 2410 is formed on another side of the retention bracket 2402 or in instances where additional orientation tabs are formed on the retention bracket 2402, one or more of the orientation tabs may extend past the sides of the rail 302 and one or more of the orientation tabs may extend into the channel 304. Thus, in these orientations, the orientation of the retention bracket 2402 may be connected to and positioned with respect to the rail 302 to cause the ground wire(s) 308 to run perpendicular to the rail 302 or to run parallel with the rail 302.

The first plate 2404-1 and the second plate 2404-2 may include a first aperture 2408-1 defined in the first plate 2404-1 and a second aperture 2408-2 defined in the second plate 2404-2. The first aperture 2408-1 and the second aperture 2408-2 may accommodate for the t-bolt 200 of FIG. 2 to extend through the retention bracket 2402 and connect the retention bracket 2402 to the rail 302. In one example, the first aperture 2408-1 and the second aperture 2408-2 may include a circular shape to accommodate for the shaft 204 of the t-bolt 200 to ensure that the retention bracket 2402 does not move with respect to the rail 302 when the t-bolt 200 is used to connect the retention bracket 2402 to the rail 302 and clamp the ground wire(s) 308 between the nut 306 and the retention bracket 2402.

The retention bracket 2402 may be made of a metal. In one example, the retention bracket 2402 may be made by machining, milling, casting, forging, extrusion, forming, or other metal object manufacturing processes to reflect the outer shape of the first plate 2404-1 and the second plate 2404-2. The first plate 2404-1 and the second plate 2404-2 of the retention bracket 2402 may be made of a metal, and may be formed from, for example, sheet metal. In one example, the first plate 2404-1 and the second plate 2404-2 may be made by stamping the sheet metal to reflect the outer shapes of the first plate 2404-1, the second plate 2404-2, the first arched retention arm 2406-1, the second arched retention arm 2406-2, the first aperture 2408-1, the second aperture 2408-2, and the orientation tab 2410. Portions of the retention bracket 2402 may then be shaped through bending including bending the orientation tab 2410 downwards and shaping the first arched retention arm 2406-1 and the second arched retention arm 2406-2 inward towards one another. In one example, the retention bracket 2402 may further be subjected to annealing, tempering, or other heat treatments to obtain a retention bracket 2402 that is able to resist deformation from the state depicted in FIG. 24.

With reference to FIG. 24, the t-bolt 200 of the grounding lug system 2400 may be utilized to secure the retention bracket 2402 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the first aperture 2408-1 and the second aperture 2408-2 in order to secure the retention bracket 2402 to the rail 302.

The head 202 may be used to clamp the retention bracket 2402 to the rail 302 between the head 202 and the nut 306 and may include the ridges 208 formed on an underside of the head 202 closest to the shaft 204 to assist in creating an electrical grounding path between the retention bracket 2402 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

The rail 302 may include a channel 304 that runs along a length of the rail 302 to allow for the retention bracket 2402 to be connected to the rail 302 to create the grounding lug system 2400. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 2402 may be engaged with the shaft 204 via the first aperture 2408-1 and the second aperture 2408-2. In this manner, the first plate 2404-1 and the second plate 2404-2 of the retention bracket 2402 may be seated on and secured to a top surface of the rail 302.

Further, the orientation tab 2410 may extend down into the channel 304 of the rail 302 to ensure that the retention bracket 2402 cannot rotate with respect to the rail 302. In this manner, the orientation of the retention bracket 2402 may be maintained so that the ground wire(s) 308 may be retained within the retention bracket 2402 without bending the ground wire(s) 308 or causing the ground wire(s) 308 to divert from an intended path along the solar panel arrays or the rail 302. However, as described above, the retention bracket 2402 may be oriented such that the ground wire(s) 308 are connected to the retention bracket 2402 and the retention bracket 2402 is oriented with respect to the rail 302 such that the ground wire(s) 308 is running perpendicularly and/or parallel with the rail 302 based on the orientation as described above.

As depicted in FIG. 24, the orientation tab 2410 is depicted as they extend downward into the channel 304 of the rail 302. Further, the head 202 of the t-bolt 200 is depicted as engaged with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 are depicted as engaging with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 2402 and/or the threads 206 of the shaft 204, and the electrical ground path may flow from the retention bracket 2402 and/or the threads 206 of the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc, are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

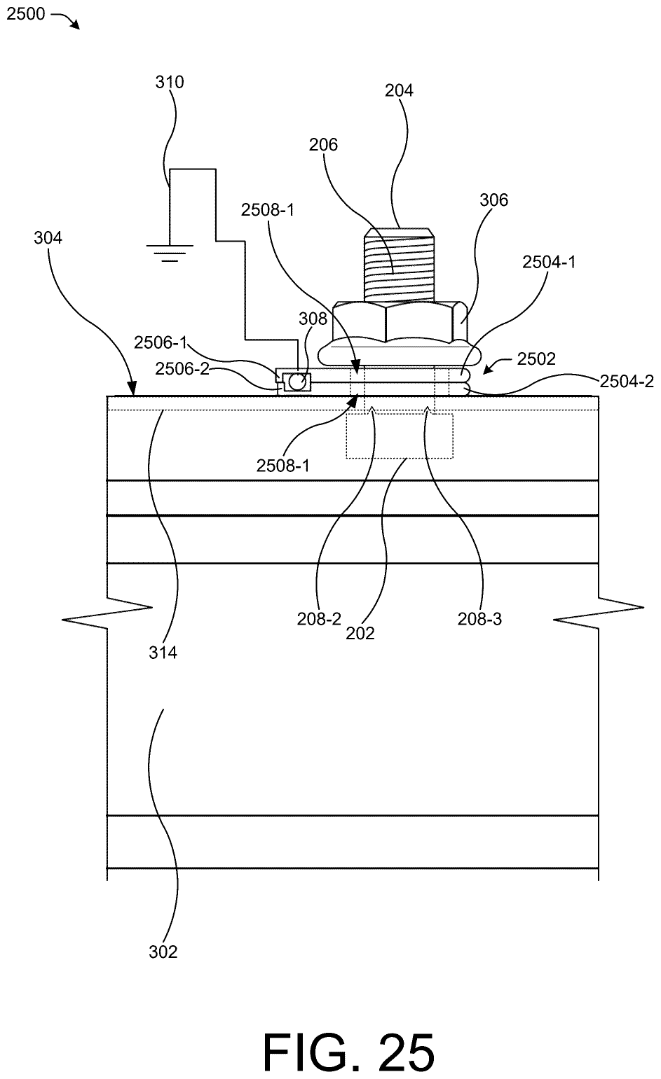

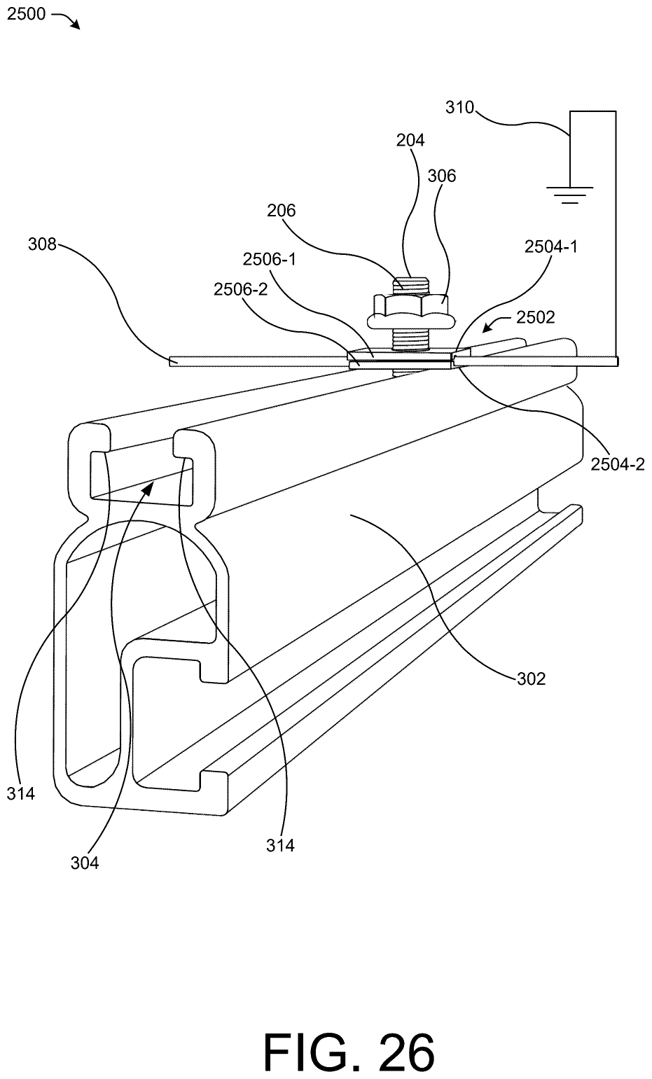

FIG. 25 illustrates a side view of a retention bracket 2502 incorporated with a grounding lug system 2500 and connected with a rail 302, according to an example of the principles described herein. FIG. 26 illustrates a top perspective view of the retention bracket 2502 incorporated with a grounding lug system 2500 of FIG. 25 and connected with a rail 302, according to an example of the principles described herein. The retention bracket 2502 may include a first plate 2504-1 and a second plate 2504-2 that mates with the first plate 2504-1. The second plate 2504-2 may include features that interface with the first plate 2504-1 to create an enclosed space in which the wire(s) 308 may be seated.

The first plate 2504-1 may include a first squared retention arm 2506-1 extending from an end of the first plate 2504-1. The second plate 2504-2 may include a second squared retention arm 2506-2. The first squared retention arm 2506-1 and the second squared retention arm 2506-2 may be formed on the same sides of the first plate 2504-1 and the second plate 2504-2, respectively. In one example, the first squared retention arm 2506-1 and the second squared retention arm 2506-2 may have different dimensions or sizes to allow for different gauges or sizes of ground wire(s) 308 to be secured between the first squared retention arm 2506-1 and the second squared retention arm 2506-2 as depicted in, for example, FIGS. 25 and 26. Further, the first squared retention arm 2506-1 and the second squared retention arm 2506-2 may be dimensioned to interface with one another to enclose the ground wire(s) 308 within a negative space created by the first squared retention arm 2506-1 and the second squared retention arm 2506-2. When the nut 306 is tightened, the first plate 2504-1 may be forced into an engaged position with the second plate 2504-2 such that the ground wire(s) 308 are retained between the internal portions of the first plate 2504-1 and the first squared retention arm 2506-1 and the second squared retention arm 2506-2, respectively.

The first plate 2504-1, in one example, may include one or more orientation tabs as described in other examples herein. The orientation tabs, if included, may extend from the second plate 2504-2 and turn downwards below the second plate 2504-2. As in other example retention brackets described herein, the orientation tabs may be used to retain the retention bracket 2502 in a desired orientation with respect to the rail 302 to which the retention bracket 2502 may be connected and may do so such that the orientation of the retention bracket 2502 may be connected to and positioned with respect to the rail 302 to cause the ground wire(s) 308 to run perpendicular to the rail 302 or parallel with the rail 302.

The first plate 2504-1 and the second plate 2504-2 may include a first aperture 2508-1 defined in the first plate 2504-1 and a second aperture 2508-2 defined in the second plate 2504-2. The first aperture 2508-1 and the second aperture 2508-2 may accommodate for the t-bolt 200 of FIG. 2 to extend through the retention bracket 2502 and connect the retention bracket 2502 to the rail 302. In one example, the first aperture 2508-1 and the second aperture 2508-2 may include a circular shape to accommodate for the shaft 204 of the t-bolt 200 to ensure that the retention bracket 2502 does not move with respect to the rail 302 when the t-bolt 200 is used to connect the retention bracket 2502 to the rail 302 and clamp the ground wire(s) 308 between the nut 306 and the retention bracket 2502.

The retention bracket 2502 may be made of a metal. In one example, the retention bracket 2502 may be made by machining, milling, casting, forging, extrusion, forming, or other metal object manufacturing processes to reflect the outer shape of the first plate 2504-1 and the second plate 2504-2. In one example, the first plate 2504-1 and the second plate 2504-2 of the retention bracket 2502 may be made of a metal, and may be formed from, for example, sheet metal. In one example, the first plate 2504-1 and the second plate 2504-2 may be made by stamping the sheet metal to reflect the outer shapes of the first plate 2504-1, the second plate 2504-2, the first squared retention arm 2506-1, the second squared retention arm 2506-2, the first aperture 2508-1, and the second aperture 2508-2. Portions of the retention bracket 2502 may then be shaped through bending. In one example, the retention bracket 2502 may further be subjected to annealing, tempering, or other heat treatments to obtain a retention bracket 2502 that is able to resist deformation from the state depicted in FIGS. 25 and 26. Further, the first squared retention arm 2506-1 and the second squared retention arm 2506-2 may be bent to form their shapes.

As similarly described in other examples herein, the t-bolt 200 of the grounding lug system 1400 may be utilized to secure the retention bracket 2502 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the first aperture 2508-1 and the second aperture 2508-2 in order to secure the retention bracket 2502 to the rail 302.

The head 202 may be used to clamp the retention bracket 2502 to the rail 302 between the head 202 and the nut 306 and may include the ridges 208 formed on an underside of the head 202 closest to the shaft 204 to assist in creating an electrical grounding path between the retention bracket 2502 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

With the description of the retention bracket 2502 and the t-bolt 200 above, FIGS. 25 and 26 illustrates a side view of the grounding lug system 2600 including the retention bracket 2502 of FIGS. 25 and 26 and the t-bolt 200 as viewed from a side of the retention bracket 2502. The rail 302 may include a channel 304 that runs along a length of the rail 302 to allow for the retention bracket 2502 to be connected to the rail 302 to create the grounding lug system 2500. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 2502 may be engaged with the shaft 204 via the first aperture 2508-1 and the second aperture 2508-2. In this manner, the first plate 2504-1 and the second plate 2504-2 of the retention bracket 2502 may be seated on and secured to a top surface of the rail 302.

Further, the head 202 of the t-bolt 200 is depicted as engaged with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 are depicted as engaging with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 2502, and the electrical ground path may flow from the retention bracket 2502 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc., are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the first squared retention arm 2506-1 and the second squared retention arm 2506-2 of the retention bracket 2502. At this position, the ground wire(s) 308 may be secured in the retention bracket 2502 via the nut 306 between the first plate 2504-1 and second plate 2504-2. The ground wire(s) 308 may form the grounding path through the first plate 2504-1 and second plate 2504-2, the shaft 204 and head 202 of the t-bolt 200, into the rail 302, and onto ground 310.

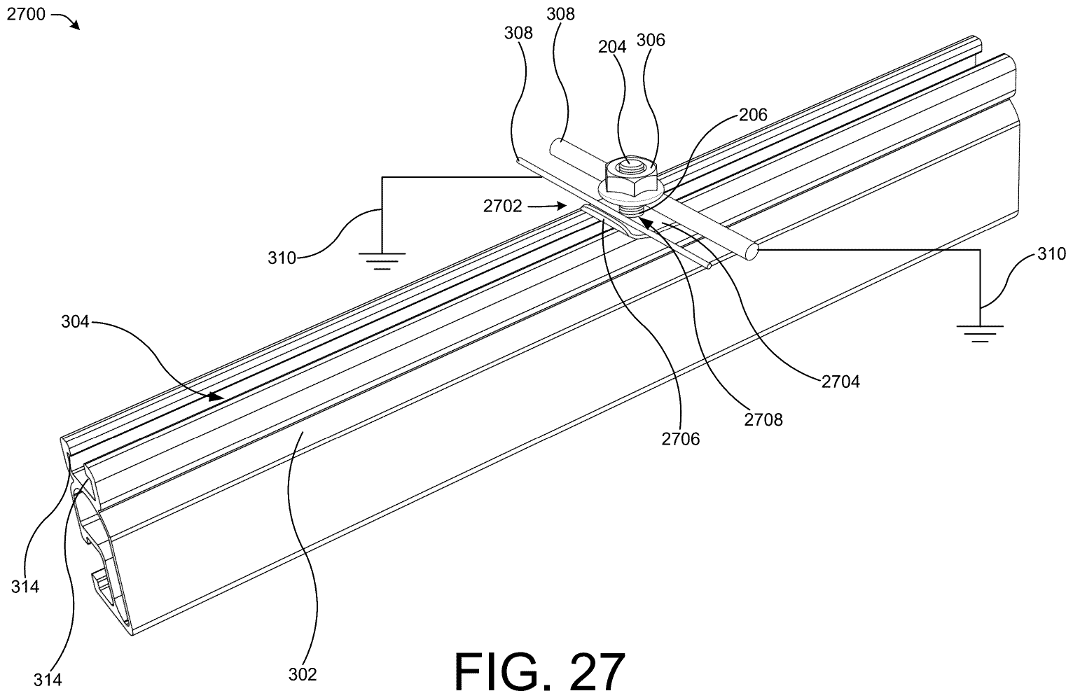

FIG. 27 illustrates a top perspective view of a retention bracket 2702 incorporated with a grounding lug system 2700 and connected with a rail 302, according to an example of the principles described herein. The retention bracket 2702 may include a main body 2704 and an at least one upturned protrusion 2706 extending upwards from and above the main body 2704. The upturned protrusion 2706 may function as a position along a length of the main body 2704 of the retention bracket 2702 at which the ground wire(s) 308 may be seated and may be dimensioned to accommodate ground wires of various gauges. The upturned protrusion 2706 may force the ground wire(s) 308 against the shaft 204 of the t-bolt 200 and, more specifically, against the threads 206 formed on the shaft 204. In this manner, the upturned protrusion 2706 serves to retain any wires (e.g., the ground wire(s) 308) that are introduced into the space between the retention bracket 2702 and the nut 306. In other words, the nut 306 serves as the element that secures the ground wire(s) 308 to the retention bracket 2702.

The main body 2704 may include an aperture 2708 defined therein. The aperture 2708 may accommodate for the t-bolt 200 of FIG. 2 to extend through the retention bracket 2702 and connect the retention bracket 2702 to the rail 302. In one example, the aperture 2708 may include a circular shape to accommodate for the shaft 204 of the t-bolt 200 to ensure that the retention bracket 2702 does not move with respect to the rail 302 when the t-bolt 200 is used to connect the retention bracket 2702 to the rail 302 and clamp the ground wire(s) 308 between the nut 306 and the retention bracket 2702.

Further, although not depicted, the retention bracket 2702 may include one or more orientation tabs that extend from the main body 2704 and turn downwards below the main body 2704. As in other example retention brackets described herein, the orientation tabs may be used to retain the retention bracket 2702 in a desired orientation with respect to the rail 302 to which the retention bracket 2702 may be connected.

As mentioned above, apart from managing the placement of the ground wire(s) 308 along a length of a solar panel array and ensuring the ground wire(s) 308 is secured to the solar panel array, the grounding lug system 2700 may further serve as an electrical conduit for the ground wire(s) 308. The main body 2704 may be shaped, dimensioned, bent or formed to contact a portion of the rail 302. For example, the main body 2704 may contact a top, exterior portion of the first return flange 704-1 and the second return flange 704-2 that extend from a first leg 702-1 and a second leg 702-2 of the rail 302. In one example, the main body 2704 may create markings on the rail similar to markings 802 created when the grounding lug system 2700 is connected with the rail 302 as depicted in FIG. 8. As depicted in FIG. 8, the markings 802 indicate a position where two separate grounding lug systems 2700 have been connected to the rail 302. The markings 802 indicate that the main body 2704, when securely connected to the first return flange 704-1 and the second return flange 704-2 of the rail 302, may deform or cut into the material of the rail 302. Further, the main body 2704 may, in this manner, cut through any oxidation, paint, or other layers that may coat the rail 302. This ensures that the electrical conduit for the ground wire(s) 308 may successfully travel from the grounding lug system 2700, to the rail 302, and onto ground 310.

The retention bracket 2702 may be made of a metal, and may be formed from, for example, sheet metal. In one example, the retention bracket 2702 may be made by stamping the sheet metal to reflect the outer shape of the main body 2704, the upturned protrusion 2706, and the aperture 2708. Portions of the retention bracket 2702 may also be shaped through bending including bending the main body 2704 to form the upturned protrusion 2706. In one example, the retention bracket 2702 may further be subjected to annealing, tempering, or other heat treatments to obtain a retention bracket 2702 that is able to resist deformation from the state depicted in FIG. 27.

With reference to FIG. 27, the t-bolt 200 of the grounding lug system 2700 may be utilized to secure the retention bracket 2702 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the aperture 2708 in order to secure the retention bracket 2702 to the rail 302.

The head 202 may be used to clamp the retention bracket 2702 to the rail 302 between the head 202 and the nut 306 and may include the ridges 208 formed on an underside of the head 202 closest to the shaft 204 to assist in creating an electrical grounding path between the retention bracket 2702 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

The rail 302 may include the channel 304 that runs along a length of the rail 302 to allow for the retention bracket 2702 to be connected to the rail 302 to create the grounding lug system 2700. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 2702 may be engaged with the shaft 204 via the aperture 2708. In this manner, the main body 2704 of the retention bracket 2702 may be seated on and secured to a top surface of the rail 302.

The retention bracket 2702 may include orientation tabs as described herein, but in the example of FIG. 27, the retention bracket 2702 does not include orientation tabs. This allows the retention bracket 2702 to be connected to the rail 302 at any orientation and secure the ground wire(s) 308 at any angle that may be beneficial to the location of the ground wire(s) 308. Further, in this manner, the orientation of the retention bracket 2702 may be maintained by securing the nut 306 to the t-bolt 200 such that the ground wire(s) 308 may be retained within the retention bracket 2702 without bending the ground wire(s) 308 or causing the ground wire(s) 308 to divert from an intended path along the solar panel arrays or the rail 302. In the example of FIG. 27, the ground wire(s) 308 is connected to the retention bracket 2702 and the retention bracket 2702 is oriented with respect to the rail 302 such that the ground wire(s) 308 is running perpendicular to the rail 302. However, as demonstrated in other examples, the retention bracket 2702 may be configured to allow for the ground wire(s) 308 to run perpendicularly with respect to the rail 302, parallel with respect to the rail 302, or at any angle with respect to the rail 302.

As depicted in FIG. 27, the head 202 of the t-bolt 200 is depicted as engaged with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 are depicted as engaging with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 2702, the nut, and/or the threads 206 of the shaft 204, and the electrical ground path may flow from the retention bracket 2702 and/or the threads 206 of the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc, are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the upturned protrusion 2706 of the retention bracket 2702. At this position, the ground wire(s) 308 may be secured in the retention bracket 2702 via the nut 306, and the upturned protrusion 2706 may be positioned along a length of the main body 2704 to force the ground wire(s) 308 against the threads 206 of the shaft 204 of the t-bolt 200. In one example, the threads 206 may engage with the ground wire(s) 308 during installation and tightening of the nut 306 against the ground wire(s) 308 and the retention bracket 2702. In this manner, the relatively softer metal (e.g., copper) of the ground wire(s) 308 may be deformed (e.g., elastic deformation or plastic deformation) by the threads 206 as the upturned protrusion 2706 forces the ground wire(s) 308 against the threads 206. Further, as depicted in FIG. 27, two ground wires 308 may be secured by the retention bracket 2702 with a first ground wire 308 being secured between the upturned protrusion 2706, the t-bolt 200 and the nut 306. Further, a second ground wire 308 may be secured between the nut 306 and the main body 2704. In one example, a plurality of ground wires 308 may be secured between the upturned protrusion 2706, the t-bolt 200 and the nut 306.

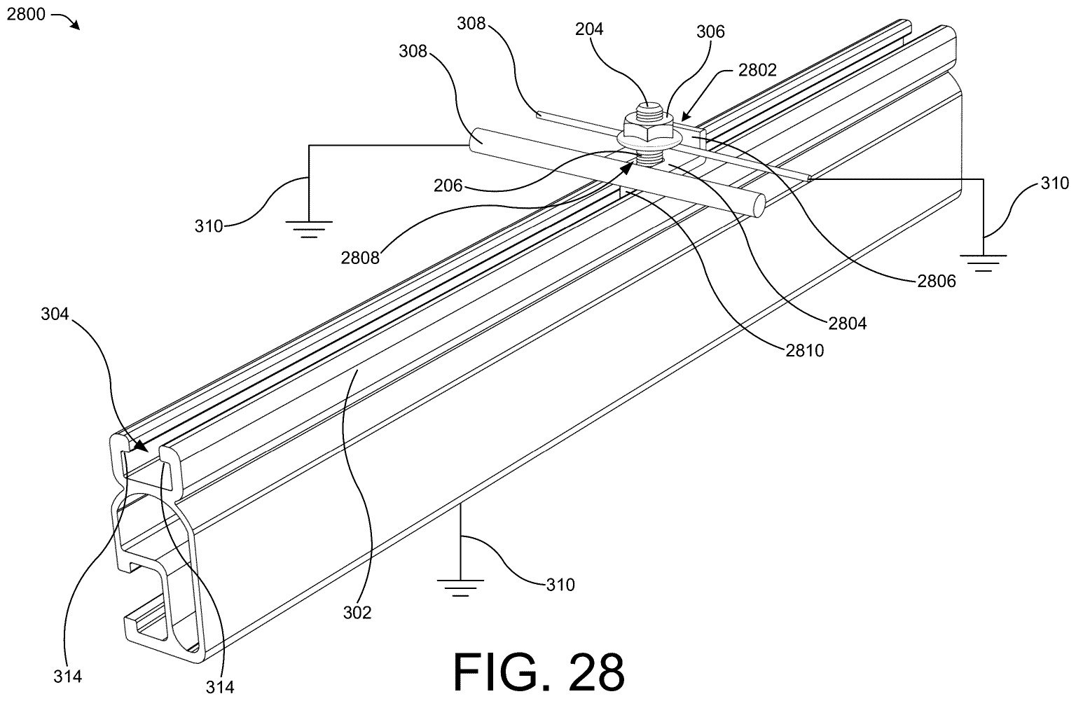

FIG. 28 illustrates a top perspective view of a retention bracket 2802 incorporated with a grounding lug system 2800 and connected with a rail 302, according to an example of the principles described herein. The retention bracket 2802 may include a main body 2804 and a buttress wall 2806 extending upwards from and above the main body 2804. The buttress wall 2806 may function as a position along a length of the main body 2804 of the retention bracket 2802 at which the ground wire(s) 308 may be seated and may be dimensioned to accommodate ground wires of various gauges. The buttress wall 2806 may force the ground wire(s) 308 against the shaft 204 of the t-bolt 200 and, more specifically, against the threads 206 formed on the shaft 204. In this manner, the buttress wall 2806 serves to retain any wires (e.g., the ground wire(s) 308) that are introduced into the space between the retention bracket 2802 and the nut 306. In other words, the nut 306 serves as the element that secures the ground wire(s) 308 to the retention bracket 2802.

The main body 2804 may include an aperture 2808 defined therein. The aperture 2808 may accommodate for the t-bolt 200 of FIG. 2 to extend through the retention bracket 2802 and connect the retention bracket 2802 to the rail 302. In one example, the aperture 2808 may include a circular shape to accommodate for the shaft 204 of the t-bolt 200 to ensure that the retention bracket 2802 does not move with respect to the rail 302 when the t-bolt 200 is used to connect the retention bracket 2802 to the rail 302 and clamp the ground wire(s) 308 between the nut 306 and the retention bracket 2802. In one example, the aperture 2808 may include an elliptical shape to allow for ground wire(s) of various sizes or gauges to be secured between the buttress wall 2806, the main body 2804, the t-bolt 200 and the nut 306.

Further, an orientation tab 2810 may extend from the main body 2804 and turn downwards below the main body 2804. As in other example retention brackets described herein, the orientation tab 2810 may be used to retain the retention bracket 2802 in a desired orientation with respect to the rail 302 to which the retention bracket 2802 may be connected.

As mentioned above, apart from managing the placement of the ground wire(s) 308 along a length of a solar panel array and ensuring the ground wire(s) 308 is secured to the solar panel array, the grounding lug system 2800 may further serve as an electrical conduit for the ground wire(s) 308. The main body 2804 may be shaped, dimensioned, bent or formed to contact a portion of the rail 302. For example, the main body 2804 may contact a top, exterior portion of the first return flange 704-1 and the second return flange 704-2 that extend from a first leg 702-1 and a second leg 702-2 of the rail 302. In one example, the main body 2804 may create markings on the rail similar to markings 802 created when the grounding lug system 2800 is connected with the rail 302 as depicted in FIG. 8. As depicted in FIG. 8, the markings 802 indicate a position where two separate grounding lug systems 2800 have been connected to the rail 302. The markings 802 indicate that the main body 2804, when securely connected to the first return flange 704-1 and the second return flange 704-2 of the rail 302, may deform or cut into the material of the rail 302. Further, the main body 2804 may, in this manner, cut through any oxidation, paint, or other layers that may coat the rail 302. This ensures that the electrical conduit for the ground wire(s) 308 may successfully travel from the grounding lug system 2800, to the rail 302, and onto ground 310.

The retention bracket 2802 may be made of a metal, and may be formed from, for example, sheet metal. In one example, the retention bracket 2802 may be made by stamping the sheet metal to reflect the outer shape of the main body 2804, the buttress wall 2806, and the aperture 2808. Portions of the retention bracket 2802 may also be shaped through bending including bending the main body 2804 to form the buttress wall 2806. In one example, the retention bracket 2802 may further be subjected to annealing, tempering, or other heat treatments to obtain a retention bracket 2802 that is able to resist deformation from the state depicted in FIG. 28.

With reference to FIG. 28, the t-bolt 200 of the grounding lug system 2800 may be utilized to secure the retention bracket 2802 to the rail 302. The t-bolt 200 as mentioned above may include a head 202 perpendicularly connected to the shaft 204. The shaft 204 may include the threads 206 formed thereon to allow the shaft 204 to engage with a mating nut 306 through the aperture 2808 in order to secure the retention bracket 2802 to the rail 302.

The head 202 may be used to clamp the retention bracket 2802 to the rail 302 between the head 202 and the nut 306 and may include the ridges 208 formed on an underside of the head 202 closest to the shaft 204 to assist in creating an electrical grounding path between the retention bracket 2802 and the rail 302. In one example, the ridges 208 may be deformed and/or may deform a portion of the rail when engaged with the rail to break through any coatings or oxidation layers present on the rail 302 and, therefore, further ensure that the grounding path is created between the t-bolt 200 and the rail 302 is created. A width of the head 202 of the t-bolt 200 may be narrow enough to fit within the channel 304 of the rail 302 and wide enough to restrict the ability of the t-bolt 200 to rotate within the channel 304 of the rail 302.

The rail 302 may include the channel 304 that runs along a length of the rail 302 to allow for the retention bracket 2802 to be connected to the rail 302 to create the grounding lug system 2800. The t-bolt 200 may be inserted into the channel 304 via, for example, an end of the rail 302 such that the head 202 of the t-bolt 200 engages with the interior surfaces of the rail 302. Once the t-bolt 200 is engaged with the rail 302 in this manner, the retention bracket 2802 may be engaged with the shaft 204 via the aperture 2808. In this manner, the main body 2804 of the retention bracket 2802 may be seated on and secured to a top surface of the rail 302.

An orientation tab 2810 may extend from the main body 2804 and turn downwards below the main body 2804. As in other example retention brackets described herein, the orientation tab 2810 may be used to retain the retention bracket 2802 in a desired orientation with respect to the rail 302 to which the retention bracket 2802 may be connected. For example, the orientation tab 2810 may extend into the channel 304 of the rail 302 as depicted in FIG. 28 and other figures that depict a rail 302 with retention brackets that include an orientation tab.

As depicted in FIG. 28, the head 202 of the t-bolt 200 is depicted as engaged with an underside surface of the rail 302 that extends into the channel 304. Specifically, an interior portion of the first return flange 704-1 and the second return flange 704-2 that extend from the first leg 702-1 and the second leg 702-2 of the rail 302 may serve as the portion of the rail 302 to which the ridges 208 of the head 202 of the t-bolt 200 may contact. The ridges 208 are depicted as engaging with the interior portion of the first return flange 704-1 and the second return flange 704-2 of the rail 302. As mentioned above, the ridges 208 may be deformed and/or may deform the interior portion of the first return flange 704-1 and the second return flange 704-2 of the rail 302 when engaged with the rail 302 in order to break through any coatings or oxidation layers present on the rail 302 and, therefore, to ensure that the grounding path between the t-bolt 200 and the rail is created. Thus, the ground wire(s) 308 may be electrically connected to the retention bracket 2802 and/or the threads 206 of the shaft 204, and the electrical ground path may flow from the retention bracket 2802 and/or the threads 206 of the shaft 204 to the head 202 of the t-bolt 200, through the ridges 208 and to the interior portion of the first return flange 704-1 and the second return flange 704-2 of the rail 302. The rail 302 may further be connected to ground 310 via any interposing devices or infrastructure. In one example, the rail 302 may carry a fault current to the ground lug system which is connected to the ground wire 308. The ground wire 308, in turn, safely disposes a fault current to ground. In the examples described herein, any accessible potentially conductive elements and devices in the solar panel systems or photovoltaic systems such as, for example, a support structure, racking, module frames, etc., are to be electrically bonded to ground 310. The ground wire 308 may be used to bond a row of photovoltaic modules to one another or one photovoltaic array to another. However, ultimately the wire 308 will electrically couple the solar panel systems or photovoltaic systems to ground 310.

The ground wire(s) 308 may be seated within the buttress wall 2806 of the retention bracket 2802. At this position, the ground wire(s) 308 may be secured in the retention bracket 2802 via the nut 306, and the buttress wall 2806 may be positioned along a length of the main body 2804 to force the ground wire(s) 308 against the threads 206 of the shaft 204 of the t-bolt 200. In one example, the threads 206 may engage with the ground wire(s) 308 during installation and tightening of the nut 306 against the ground wire(s) 308 and the retention bracket 2802. In this manner, the relatively softer metal (e.g., copper) of the ground wire(s) 308 may be deformed (e.g., elastic deformation or plastic deformation) by the threads 206 as the buttress wall 2806 forces the ground wire(s) 308 against the threads 206. Further, as depicted in FIG. 28, two ground wires 308 may be secured by the retention bracket 2802 with a first ground wire 308 being secured between the buttress wall 2806, the t-bolt 200 and the nut 306. Further, a second ground wire 308 may be secured between the nut 306 and the main body 2804. In one example, a plurality of ground wires 308 may be secured between the buttress wall 2806, the t-bolt 200 and the nut 306.

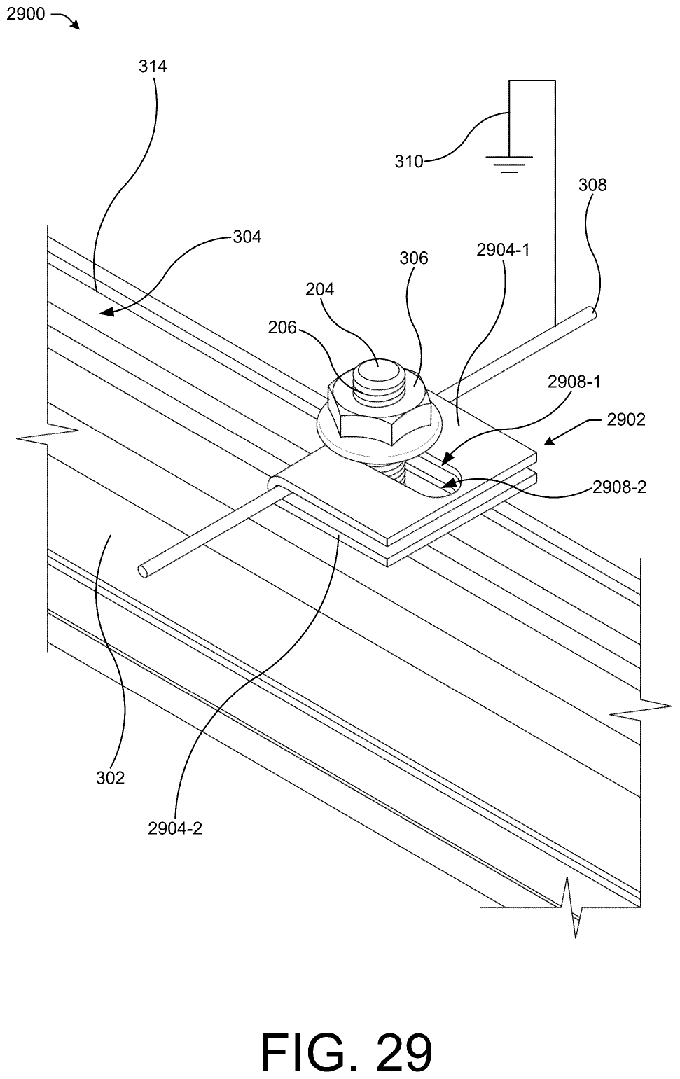

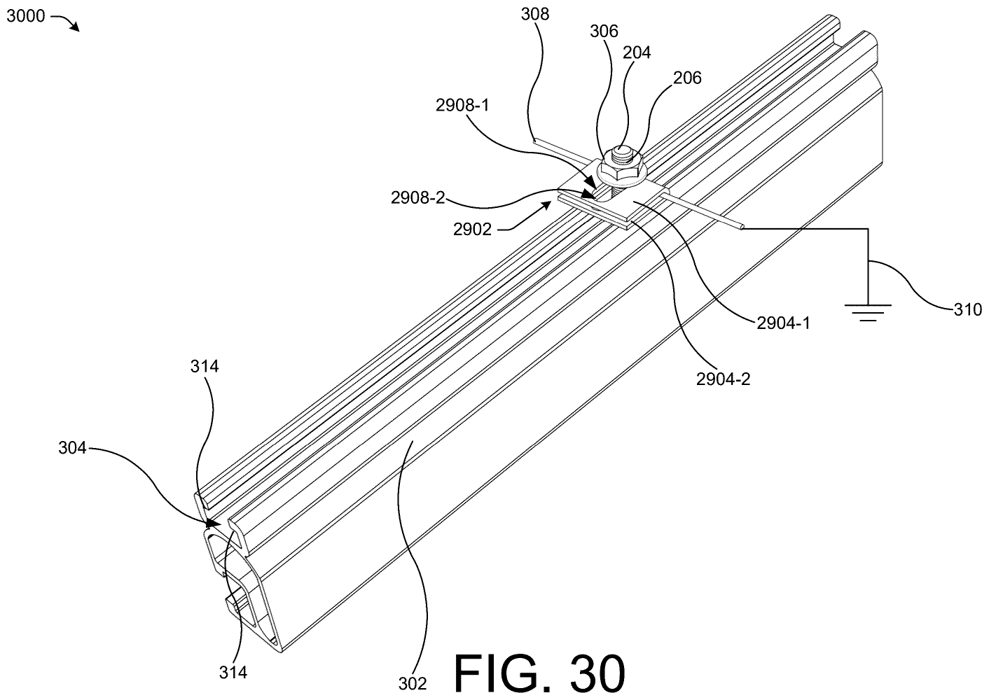

FIGS. 29 and 30 illustrates top perspective views from different angles of a grounding lug system 2900 including a retention bracket 2902 incorporated with a rail 302, according to an example of the principles described herein. FIG. 30 illustrates a top perspective view of the retention bracket 2902 incorporated with a grounding lug system 2900 of FIG. 29 and connected with a rail 302, according to an example of the principles described herein. In FIGS. 29 and 30, the retention bracket 2902 may include a first retention bracket portion 2904-1 and a second retention bracket portion 2904-2. As depicted, the retention bracket 2902 is held to the rail 302 via tightening the t-bolt 200 of FIG. 2, according to an example of the principles described herein. In an embodiment, retention bracket 2902 may be formed as a single punched quadrilateral planar material sheet. The sheet may be folded against itself, thereby aligning the first retention bracket portion 2904-1 and the second retention bracket portion 2904-2. Each of the first retention bracket portion 2904-1 and the second retention bracket portion 2904-2 may, respectively, have a first aperture 2906-1, which may be elongated, and a second aperture 2906-2, which may be elongated, that passes through the thickness thereof. The first aperture 2906-1 and the second aperture 2906-2 may be oriented laterally between the folded closed end of the retention bracket 2902 and the open ends of the first retention bracket portion 2904-1 and the second retention bracket portion 2904-2. Furthermore, the first aperture 2906-1 and the second aperture 2906-2 may be aligned and sized to allow the t-bolt 200 to pass therethrough. As such, the first retention bracket portion 2904-1 and the second retention bracket portion 2904-2 folded together form a catch area between the fold at the closed end joining the first retention bracket portion 2904-1 and the second retention bracket portion 2904-2. The catch area clamps at the folded closed end, via tightening the t-bolt 200, to secure one or more ground wires 308. An advantage of the retention bracket 2902 may be that the formation thereof and apertures therein may be achieved in a single punch from a larger sheet of material, and the retention bracket 2902 may be folded on itself to align the punched apertures 2906-1, 2906-2.

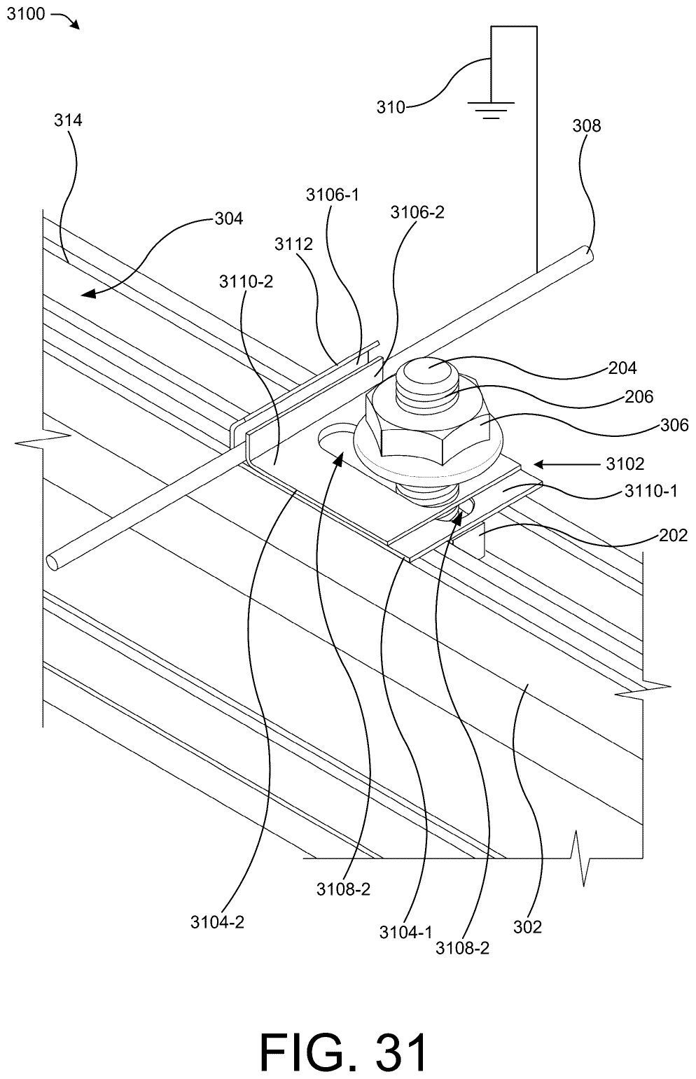

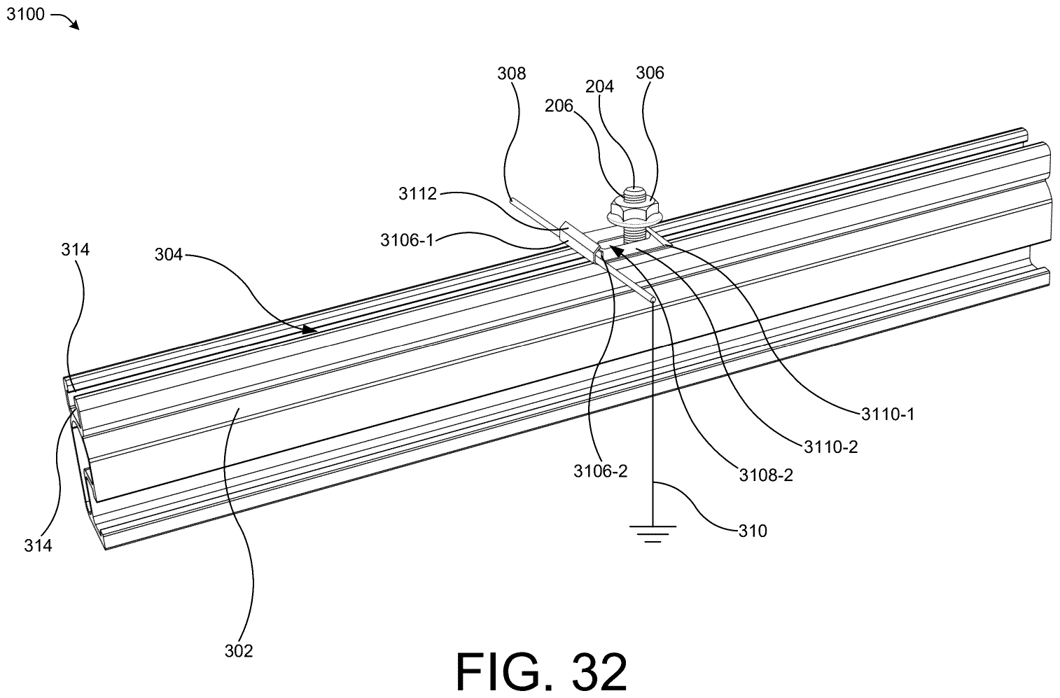

FIG. 31 illustrates a top perspective view of a retention bracket 3102 incorporated with a grounding lug system 3100 and connected with a rail 302, according to an example of the principles described herein. FIG. 32 illustrates a top perspective view of the retention bracket 3102 incorporated with a grounding lug system 3100 of FIG. 31 and connected with a rail 302, according to an example of the principles described herein. The grounding lug system 3100 may include a first retention bracket portion 3104-1 and a second retention bracket portion 3104-2 held to the rail 302 via tightening the t-bolt 200 of FIG. 2, according to an example of the principles described herein. In an embodiment, first retention bracket portion 3104-1 and second retention bracket portion 3104-2 are distinct components and may each have an L-shape cross-section including, respectively, a first flange body 3106-1 and a second flange body 3106-2, that are integrally formed with a respective third flange body 3110-1 and a fourth flange body 3110-2. Thus, the third flange body 3110-1 and the fourth flange body 3110-2 may be stacked upon each other flush against the rail 302, in which position, the first flange body 3106-1 and a second flange body 3106-2 extend away from the rail 302 and may be positioned to slide to and away from each other. In an embodiment, the first flange body 3106-1 may include a distal end 3112 that is folded partially toward the second flange body 3106-2 to form a catch area between the first flange body 3106-1 and the second flange body 3106-2. That is, the catch area may be sized larger or smaller to secure one or more ground wires 308 by sliding the first flange body 3106-1 and the second flange body 3106-2 closer together or farther apart.

Moreover, each of the respective third flange body 3110-1 and the fourth flange body 3110-2 has an elongated aperture including a first aperture 3108-1 and a second aperture 3108-2 defined therein. The t-bolt 200 may assist in retaining one or more ground wires 308 by passing through the first aperture 3108-1 and the second aperture 3108-2, sandwiching the third flange body 3110-1 and the fourth flange body 3110-2 against the upper side of the rail 302. The third flange body 3110-1 and the fourth flange body 3110-2 may be laterally shifted to close the distance between the first flange body 3106-1 and the second flange body 3106-2 and enclosing the ground wire(s) 308 in the catch area between the first flange body 3106-1 and the second flange body 3106-2 of retention bracket 3102 as depicted in FIG. 32.

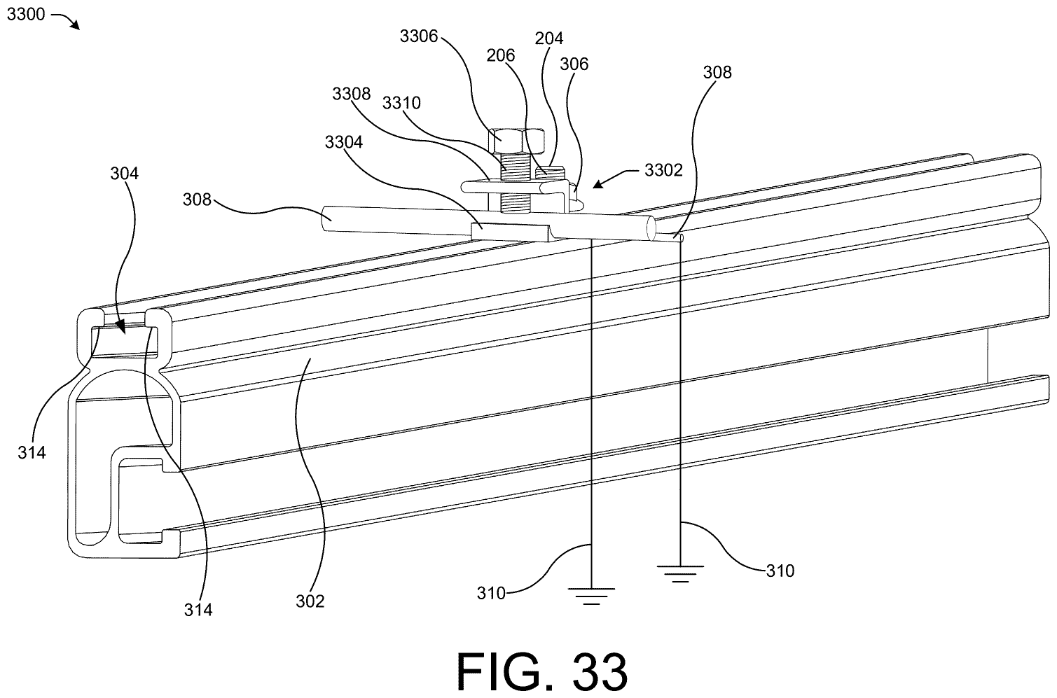

FIG. 33 illustrates a side perspective view of a retention bracket 3302 incorporated with a grounding lug system 3300 and connected with a rail 302, according to an example of the principles described herein. In FIG. 33, the grounding lug system 3300 is depicted. Notably, the grounding lug system 3300 may include a retention bracket 3302 held to the rail 302 via tightening the t-bolt 200 of FIG. 2, according to an example of the principles described herein. The t-bolt 200 is depicted in a vertical position against a back side of the body of retention bracket 3302. The retention bracket 3302 may include a J-shape or C-shape cross-section of the body such that a lower arm 3304 of the retention bracket 3302 curves away from the rail 302 and provides a catch area for one or more ground wires 308. Additionally, a set screw 3306 may be threadingly engaged through the upper arm 3308 of the retention bracket 3302, such that a shaft 3310 of the set screw 3306, extends into the catch area and may be tightened against the one or more ground wires 308 which are held captive against the lower arm 3304 of the retention bracket 3402.

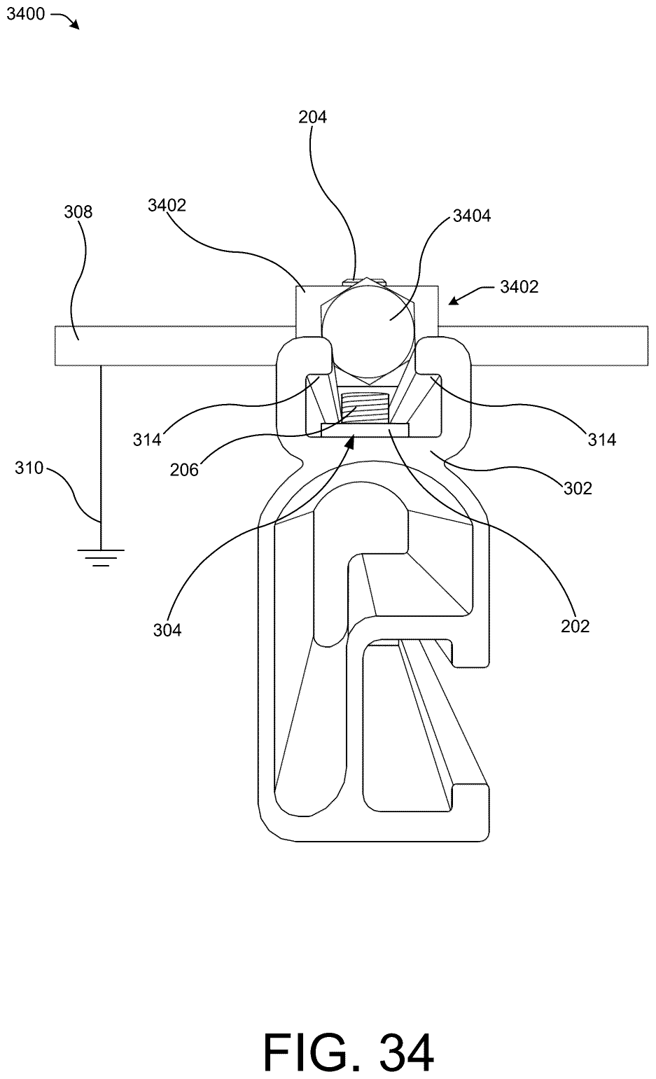

FIG. 34 illustrates a side perspective view of a retention bracket 3402 incorporated with a grounding lug system 3400 and connected with a rail 302, according to an example of the principles described herein. In FIG. 34, a grounding lug system 3400 is depicted. Notably, the grounding lug system 3400 may include a retention bracket 3402 held to the rail 302 via tightening the t-bolt 200 of FIG. 2, according to an example of the principles described herein. While the t-bolt 200 is depicted in a vertical position, a set screw 3404 is oriented such that the axis therethrough extends transversely to a central axis through the shaft 204 of the t-bolt 200, where “transversely” may include any orientation that is not parallel with the shaft 204. Set screw 3404 may threadingly engage a portion of the retention bracket 3402, as described and shown herein, to facilitate capture of the ground wire 308 either against a portion of the retention bracket 3402 or abutting the t-bolt 200.

### Conclusion

Although several embodiments have been described in language specific to structural features, it is to be understood that the claims are not necessarily limited to the specific features described. Rather, the specific features are disclosed as illustrative forms of implementing the claimed subject matter.

What is claimed is:

1. A grounding lug system comprising:
a retention bracket including:
a first leg having a first aperture defined through a thickness thereof, and
a second leg connected to the first leg via a folded portion, the second leg having a second aperture defined through a thickness thereof; and
a fastener configured to extend through the first aperture and the second aperture.

2. The grounding lug system of claim 1, wherein the retention bracket further includes a flange extending therefrom.

3. The grounding lug system of claim 2, wherein the flange is formed on an end of one of the first leg or the second leg.

4. The grounding lug system of claim 1, further comprising a depression dimensioned to retain a wire within the retention bracket.

5. The grounding lug system of claim 1, wherein the fastener includes:
a t-bolt, and
a nut mechanically connectable to the t-bolt.

6. The grounding lug system of claim 5, wherein the retention bracket is deformable as the t-bolt mechanically engages with the nut.

7. The grounding lug system of claim 1, further comprising a tab extending perpendicular to the second leg to retain an orientation of the retention bracket with respect to a rail to which the retention bracket is connectable.

8. A grounding lug system comprising:
a retention bracket including:
a first leg, and
a second leg;
a fastener sized and shaped to extend through the retention bracket; and
a tab extending perpendicular to the second leg to retain an orientation of the retention bracket with respect to a rail to which the retention bracket is connectable.

9. The grounding lug system of claim 8, further comprising a flange extending from the retention bracket.

10. The grounding lug system of claim 9, wherein the flange is formed on an end of at least one of the first leg or the second leg.

11. The grounding lug system of claim 8, further comprising a depression dimensioned to retain a wire within the retention bracket.

12. The grounding lug system of claim 8, wherein the fastener includes:
a t-bolt, and
a nut mechanically connectable to the t-bolt.

13. The grounding lug system of claim 12, wherein the t-bolt includes:
a threaded shaft,
a head connected to the threaded shaft and perpendicular to the threaded shaft, and
a ridge formed on a side of the head closest to the threaded shaft,
wherein the threaded shaft, head, and ridge include an electrically conductive material.

14. The grounding lug system of claim 8, further comprising:
a first aperture defined in a first leg of the retention bracket; and
a second aperture defined in a second leg of the retention bracket, the fastener extending through the first aperture and the second aperture.

15. A retention bracket comprising:
a first leg;
a second leg; and
a tab extending perpendicular to the second leg of the retention bracket to retain an orientation of the retention bracket with respect to a rail to which the retention bracket is connected.

16. The retention bracket of claim 15, further comprising a flange extending from the retention bracket.

17. The retention bracket of claim 16, wherein the flange is formed on an end of at least one of the first leg or the second leg.

18. The retention bracket of claim 16, wherein the flange is dimensioned to retain a wire within the retention bracket.

19. The retention bracket of claim 15, further comprising:
a first aperture defined in a first leg of the retention bracket; and
a second aperture defined in a second leg of the retention bracket.

20. The retention bracket of claim 15, wherein the retention bracket comprises an electrically conductive material.
